(19) United States
(12) Patent Application Publication
(10) Pub. No.: US 2021/0146291 A1
(43) Pub. Date: May 20, 2021

(54) FILTRATION APPARATUS AND METHOD

(71) Applicant: Paul Neiser, Mountain View, CA (US)

(72) Inventor: Paul Neiser, Mountain View, CA (US)

(21) Appl. No.: 17/098,379

(22) Filed: Nov. 14, 2020

Related U.S. Application Data
(60) Provisional application No. 62/935,100, filed on Nov. 14, 2019.

(51) Int. Cl. B01D 46/40; B01D 29/44; B63B 1/34; B62D 35/00; B61D 17/02; B64C 1/00; B64C 11/18

(52) U.S. Cl. CPC B01D 46/40; B01D 29/44; B63B 1/34; B62D 35/00; B01D 2279/40; B64C 1/0009; B64C 11/18; B01D 2201/265; B61D 17/02

(57) ABSTRACT

Provided is a filtering apparatus configured to interact with objects of interest within a medium. The properties of the filtering apparatus can be configured to modify the trajectory of individual objects of interest which interact with the filtering apparatus within several orders of magnitude of the mean free path of objects of interest. Surfaces of a filtering apparatus can be constructed to preferentially redirect objects of interest in a desired direction, such as a direction substantially parallel to a surface, or substantially along the length of a channel connecting two reservoirs. This can modify the net diffusion of objects of interest relative to the surface, which can modify the bulk fluid flow velocity magnitude along the surface. This can be employed to reduce the viscous drag on a surface moving relative to a fluid, or to generate thrust, or to convert thermal energy of a fluid into useful work.

### CLAIM OF PRIORITY

The present patent application is a non-provisional of, and claims the benefit of priority of U.S. Provisional Patent Application No. 62/886,960 filed on Aug. 14, 2019, U.S. Provisional Patent Application No. 62/935,100 filed on Nov. 14, 2019, each of which is hereby incorporated by reference herein in its entirety.

### FIELD

The present invention relates to apparatuses and methods for filtration, drag reduction, thrust generation, propulsion, or power generation. The present invention is configured to interact with a medium comprising mobile objects of interest.

### BACKGROUND

A vehicle moving relative to a fluid, such as a fuselage of an aircraft, or the hull of a ship, typically encounters a friction force, or a drag force. The friction force arises from a transfer of momentum from the wetted surface of the vehicle to the individual molecules of the fluid. In the prior art, attempts to minimize this drag force are typically limited to ensuring the wetted surface of the vehicle is as smooth as possible. In some cases, such smoothness can favor laminar flow over at least a portion of the wetted surface, which can help to reduce the viscous drag force. This drag force can be substantial even in the presence of laminar flow, however.

Filtering, pumping or changing the concentration of objects of interest typically consumes useful energy. For example, the pumping of fluid by a conventional aircraft engine during the production of thrust consumes useful energy provided separately in the form of hydrocarbon fuel or in the form of an electrical battery, for example. Similarly, in a typical desalination plant employing reverse osmosis, the separation of the solute from the solution consumes useful power in the form of electricity.

### SUMMARY

Provided is a filtering apparatus configured to interact with objects of interest, or OI, within a medium. Objects of interest can be individual molecules in a gas such as air, for example. The properties of the filtering apparatus can be configured to modify the trajectory of individual objects of interest within several orders of magnitude of the mean free path of objects of interest. At these small scales, the behavior of a fluid is no longer described by a macroscopic flow regime, such as the viscous flow regime described by the Navier-Stokes equations, but rather a rarefied gas flow regime, as exemplified by Knudsen flow, or free molecular flow. In this rarefied gas flow regime, such as the flow regime surrounding sufficiently small features, the trajectories of individual objects of interest can be modified by the shape of the sufficiently small features.

The present invention discloses surfaces which preferentially redirect objects of interest in a desired direction, such as a direction substantially parallel to a surface, or substantially along the length of a channel connecting two reservoirs. The surfaces can be designed to generate localized modifications of the fluid flow, such as an enhanced diffusion of objects of interest along the surface, which in turn can lead to macroscopic manifestations, such as a viscous bulk flow associated with the net diffusion of objects of interest along the surface. This induced diffusion can generate a fluid flow velocity, or increase the fluid flow velocity, along the surface of a vehicle moving through a fluid, which in turn can be employed to reduce the viscous drag on the vehicle, or to generate thrust acting on the vehicle.

The present invention describes a filtering apparatus with surfaces which are sufficiently small in size and suitably shaped, such that the difference between the average net rate of change of momentum of objects of interest which interact with the surface and the theoretical average net rate of change of momentum of objects of interest which interact with a flat surface in an otherwise equivalent baseline scenario has a non-zero component in a specified direction.

This property of a filtering apparatus can be employed to generate a difference in the concentration of objects of interest along a surface of a filtering apparatus, or in a second reservoir relative to a first reservoir for a static boundary condition. This property can also be employed to generate a net diffusion of objects of interest along a surface of a filtering apparatus, or through a filtering apparatus from a first reservoir to a second reservoir in a dynamic boundary condition. The energy of the net diffusion, i.e. the energy associated with the resulting bulk flow of objects of interest, is provided by the thermal energy of the objects of interest in some embodiments of the invention. The bulk flow of OI can be employed in the reduction of drag, and/or the production of thrust in an aircraft propulsion unit, for example. The bulk flow of OI can also be employed in the conversion of thermal energy of a fluid into useful work, such as into mechanical work or electrical energy.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various embodiments discussed in the present document.

FIG. 1 is a cross-sectional view of one embodiment of the invention.

FIG. 2 is a cross-sectional view of another embodiment of the invention.

FIG. 3 is a cross-sectional view of another embodiment of the invention.

FIG. 4 is a cross-sectional view of another embodiment of the invention.

FIG. 5 is a cross-sectional view of another embodiment of the invention.

FIG. 6 is a cross-sectional view of another embodiment of the invention.

FIG. 7 is a cross-sectional view of another embodiment of the invention.

FIG. 8 is a cross-sectional view of one embodiment of the invention and a schematic representation of the interaction of said embodiment with objects of interest.

### DETAILED DESCRIPTION OF THE DRAWINGS

The term “medium” used herein describes any material which is capable of containing, carrying, transporting, or transferring an object of interest. A medium can be a plasma, a gas, a liquid, a solid, or a vacuum, for example. By default, and unless specified, a medium refers to the collection of all objects which interact with a specified apparatus.

The term “object” used herein describes any component of a medium. An object can be described as a particle, such as a dust particle, a soot particle, an ice particle, a water droplet, a water molecule, a large molecule, a small molecule, or an atom. Other examples of objects are subatomic particles such as electrons, neutrons, or protons. An object can also be described as a wave, such as an acoustic wave, a seismic wave, an ocean wave, a gravity wave, a photon, or a phonon. The invention applies to any medium which can be considered to comprise distinct objects. An object can have a property of interest, as well as a defining property, which can be used to distinguish an object from other objects of the medium.

One can define a “dynamic boundary condition” as a simplified scenario in which the properties of the medium at a first reservoir and, if applicable, a second reservoir, are identical and uniform in time and space. In a dynamic boundary condition there is typically a bulk flow of objects of interest relative to the filtering apparatus in the proximity of the filtering apparatus.

One can define a “static boundary condition” as a simplified scenario in which a first and, if applicable, a second reservoir, are finite in size and, if applicable, isolated from each other and any other reservoirs apart from an embodiment of the invention, such as a filtering apparatus, allowing the exchange of OI between the first and second reservoirs. In the static boundary condition, the macroscopic properties of interest of the medium in the first and, if applicable, the second reservoirs have reached a steady state value, i.e. a value that is substantially constant in time and space, i.e. substantially uniform throughout a reservoir. Such macroscopic properties can refer to the pressure, temperature, or density of a medium, for example. In a static boundary condition there is typically, and at least initially, no bulk flow of objects of interest relative to the filtering apparatus. Note that a static boundary condition can be a condition of the medium surrounding a filtering apparatus which is valid at an instant in time, and which can transition to a dynamic boundary condition at subsequent or later instants in time.

A “default boundary condition” for an example filtering apparatus can refer to a model scenario in which the properties of the medium in a first reservoir and, if applicable, a second reservoir, are identical and uniform in time and space.

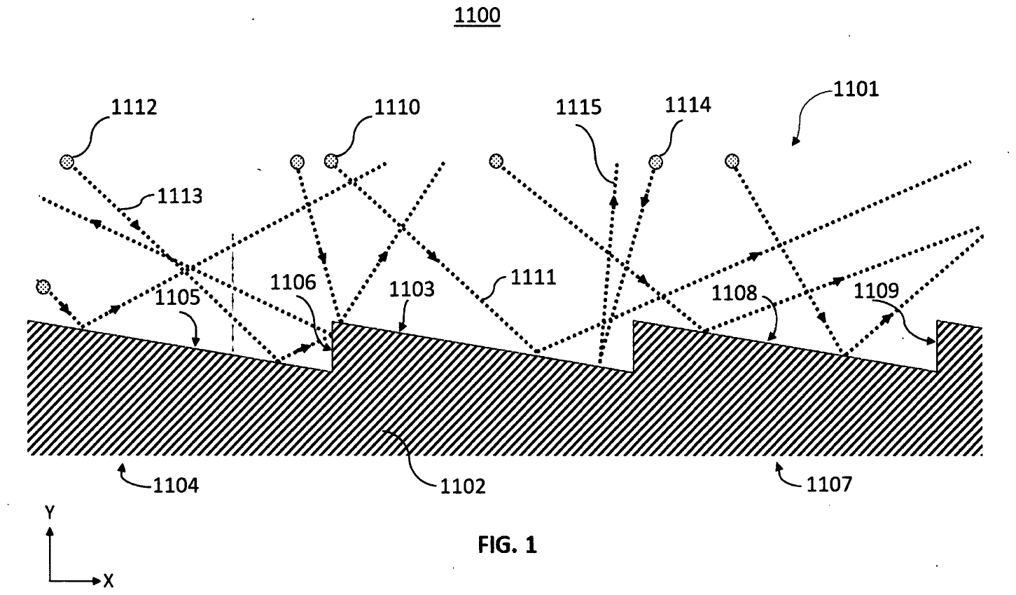

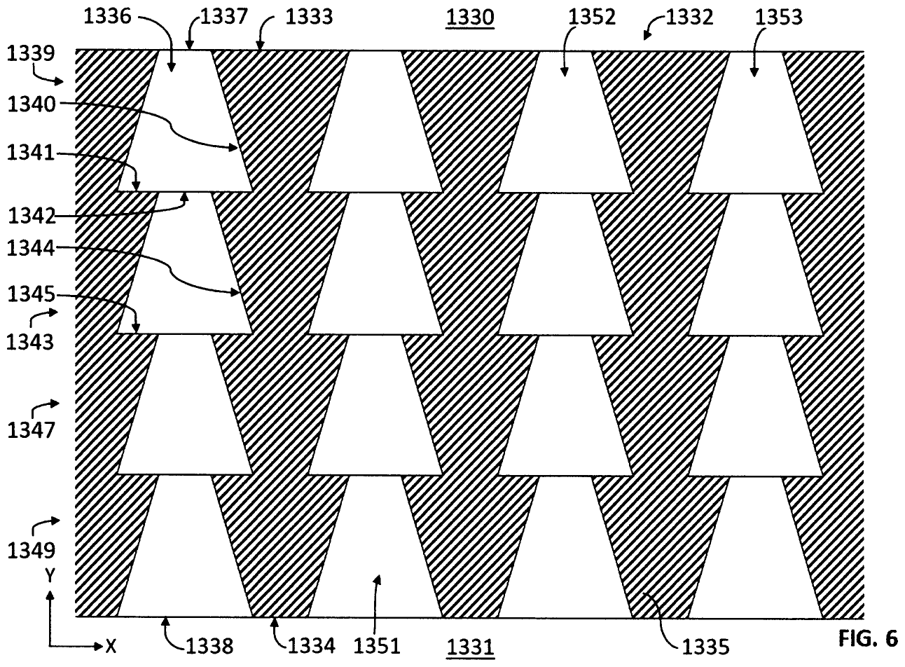

The “average surface” at a specified location is the theoretical surface location of a filtration system at a specified location, where the theoretical surface location is the average surface location calculated over a circular surface area of the filtration system surrounding the specified location, where the radius of the area is larger than 1000 mean free paths of objects of interest in the medium at the specified location. For example, in FIG. 1, the average surface is a plane parallel to the XZ-plane and located at a position along the Y-axis which describes the average location of surfaces 1108 and 1109 along the Y-axis. In another example, the average surface of a planar surface parallel to the XZ-plane coincides with the planar surface. The average surface can be considered to be the theoretical surface of a filtration system in the absence of segments of a filtration system, such as segments 1104 or 1107 in FIG. 1. In general, the average surface is three-dimensional. In FIGS. 1-5 the average surface is a continuous two-dimensional surface parallel to the XZ-plane. In FIGS. 6-8 the average surface comprises two surfaces parallel to the XZ-plane at the interface to the first and second reservoirs, as well as cylindrical wall surfaces of channels coupling the first and second reservoirs, as described in the context of the “baseline scenario”.

A “baseline scenario” can refer to a scenario in which an example embodiment comprising a filtering apparatus is replaced by a “baseline apparatus” or a “baseline filtration system” comprising an equivalent filtering apparatus with a geometry described by the average surface of the filtration system to which it is being compared. The baseline apparatus consists of the same bulk material as the filtration system to which it is being compared, and the baseline apparatus is subjected to the same boundary conditions as the filtration system to which it is being compared. Unless specified or clear from context, the baseline apparatus is subjected to default boundary conditions. In FIGS. 1-5 the baseline apparatus is a planar, two-dimensional surface parallel to the XZ-plane and consisting of the same bulk material as the filtration system with which it is being compared. In FIGS. 6-8 the baseline apparatus is a flat plate of same thickness along the Y-direction as the filtration apparatus shown in the figures, where the flat plate comprises straight circular channels of constant cross-sectional area and geometry along the length of the channel, where the circular channels diffusively couple the first reservoir with the second reservoir, and where the centroid of the circular channels is parallel to the Y-axis, and where the cross-sectional area of the channels is identical to the average cross-sectional area of the channels of the filtration system shown in the figures.

A “baseline probability” can refer to the probability for any object which interacts with a baseline apparatus to be located at a specified side of the baseline apparatus after the interaction is completed in a baseline scenario. For example, the baseline probability can be 50% for any side of the baseline apparatus.

The “characteristic width” of a focusing apparatus is the extent of a focusing apparatus in a direction perpendicular to a local flow of objects of interest which interact with the focusing apparatus.

The “characteristic length” of a focusing apparatus is the average displacement of objects of interest throughout an interaction with a focusing apparatus within a filtering apparatus.

The “characteristic dimension” of a focusing apparatus is the average distance travelled by objects of interest throughout an interaction with a focusing or deflection apparatus. In general, the characteristic dimension is a dimension which is relevant to the way in which the filtering apparatus interacts with objects of interest.

FIG. 1 is a cross-sectional view of one embodiment of the invention. Some features of the apparatus shown in FIG. 1, as well as some of the principles of operation of the apparatus share similarities with the apparatus shown in the other figures, and will therefore not be described in the same detail in the context of FIG. 1, and vice versa.

There is a first reservoir 1100, in which the medium comprises objects of interest, or “OI”, which are schematically represented by individual particles, such as the schematic representation of OI 1112. OI are assumed to be spherical in shape in this simplified embodiment. In FIG. 1, for simplicity, the medium can be considered to be an ideal gas comprising monatomic molecules. In other embodiments the medium can consist of other types of objects, such as water molecules. In other embodiments, OI need not be spherical, but can take any shape. For example, OI can be a diatomic molecule, or a polyatomic molecule, or an aerosol particle like a dust particle or pollen, which can take a wide variety of shapes. A medium can also comprise several different types of objects, such as sodium and chlorine ions found in salt water, or electrons in a conductor. An OI can also be a subatomic particle such as an electron, positron, or photon. An OI can also be a virtual particle, or virtual object, such as a virtual photon, a virtual electron, virtual quarks, or a virtual positron, as describe by quantum field theory. These virtual particles give rise to the zero point energy and associated effects, such as the Casimir effect. Note that the mean free path of virtual particles can be on the order of tens of nanometers. Note that virtual particles also exist in a vacuum.

The filtering plate 1101 comprises a bulk material 1102, which comprises a first surface 1103. Bulk material 1102 can be made of any suitable material, such as metal, composite, or ceramic. In some embodiments, bulk material 1102 can also be described as a fabric. Bulk material 1102 can comprise graphene in some embodiments. Bulk material 1102 is configured to be perfectly reflective to OI in this embodiment. In other embodiments, bulk material 1102 can have a reflectivity which is greater than zero and less than one. Note that the reflections can be specular or diffuse in this embodiment and embodiments of this type. In the depicted scenario, the reflections of OI from the surface 1103 of bulk material 1102 are specular.

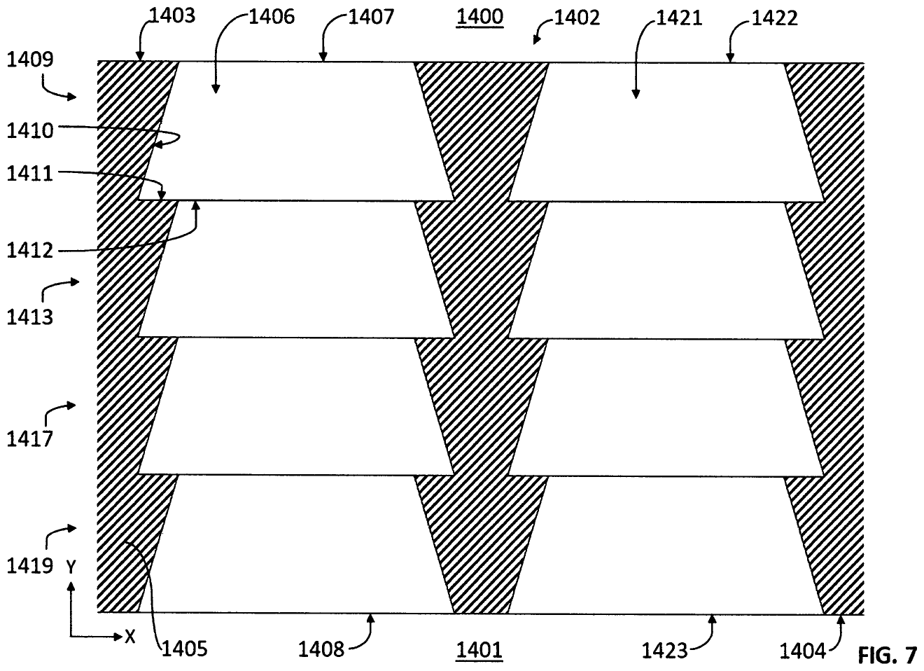

In this embodiment surface 1103 is planar and comprises segments of two dimensional surfaces, such as surface 1105 and surface 1106. Surface 1106 is two dimensional and parallel to the YZ-plane. Surface 1103 can be considered to be generated by the extrusion of bulk material 1102 in the positive or negative Z-direction. In other embodiments, such as the embodiment depicted in FIG. 7, the surface 1103 can also be cylindrical or circular in three-dimensional form when viewed in the X-direction in FIG. 1. In other embodiments, surface 1103 can also be elliptical, square, or rectangular in form when viewed in the X-direction in FIG. 1. In other embodiments, surface 1103 can be in any three dimensional form, provided the principles of operation are maintained.

Surface 1103 comprises several identically configured segments, such as segment 1104 or segment 1107. Each segment can be considered to be a focusing apparatus, or a deflection apparatus, which is configured to deflect or redirect objects of interest which interact with surface 1103 in a desired direction. In embodiment 1101, each segment comprises a first surface, such as first surface 1105 or first surface 1108, and a second surface, such as second surface 1106, or second surface 1109. In FIG. 1, the first surface 1105 is inclined at an angle, such that the surface normal is directed in the positive X-direction and in a plane parallel to the XY-plane. The angle between the surface normal and the Y-axis is denoted the “inclination angle”. The inclination angle can range from a value greater than zero degrees to a value smaller than ninety degrees. The extent of a segment, such as segment 1104 or segment 1107 along the X-axis, which in this case is also equal to the extent of the first surface along the X-axis, is denoted the “width of a segment”. The “depth of a segment” is the extent of a segment along the Y-axis, which in this case is also equal to the extent of the first surface along the Y-axis, or the extent of a second surface, such as second surface 1106 or second surface 1109, along the Y-axis. In this embodiment, the second surfaces, such as second surface 1106, is planar in shape and parallel to the YZ-plane.

Examples of interactions between OI and the bulk material 1102 are shown in FIG. 1, as exemplified by trajectory 1113 of OI 1112, trajectory 1111 of OI 1110, or trajectory 1115 of OI 1114. As a result of the aforementioned inclination angle of the first surfaces, such as first surface 1105 or first surface 1108, the motion of OI after colliding with the first surfaces is preferentially in the positive X-direction.

Note that the type of interaction between the OI and the filtering plate 1101 is a function of the inclination angle and the width of a segment, amongst other parameters such as parameters pertaining to the mean free path of objects of interest in the surrounding medium. For a certain value of such parameters, the OI which approach the surface 1103 can, on average, experience a net deflection in the positive X-direction in some embodiments. In a dynamic boundary condition, this can lead to a net diffusion, or a bulk flow, of OI in the positive X-direction. An “initial velocity” is the velocity of an OI immediately prior to interacting with apparatus 1101, i.e. prior to colliding with surface 1103, e.g. with a first surface 1105 or a second surface 1106. A “final velocity” is the velocity of an OI immediately after interacting with apparatus 1101, i.e. after colliding with surface 1103, e.g. with a first surface 1105 or a second surface 1106. Due to the geometry of the surface 1103, the average initial velocity vector of OI can be different to the average final velocity vector of OI. For example, in a hypothetical scenario, such as a scenario in which there is a static boundary condition, the average initial velocity can be directed in the negative Y-direction and parallel to the Y-axis, while the average final velocity can be directed in the positive X- and Y-direction. The non-zero component in the positive X-direction can lead to a net diffusion of OI in the positive X-direction. In other embodiments, or other applications, the average component of the final velocity in the positive X-direction can be larger than the average component of the initial velocity in the positive X-direction, where the average is calculated over all OI which interact with the filtering apparatus 1101.

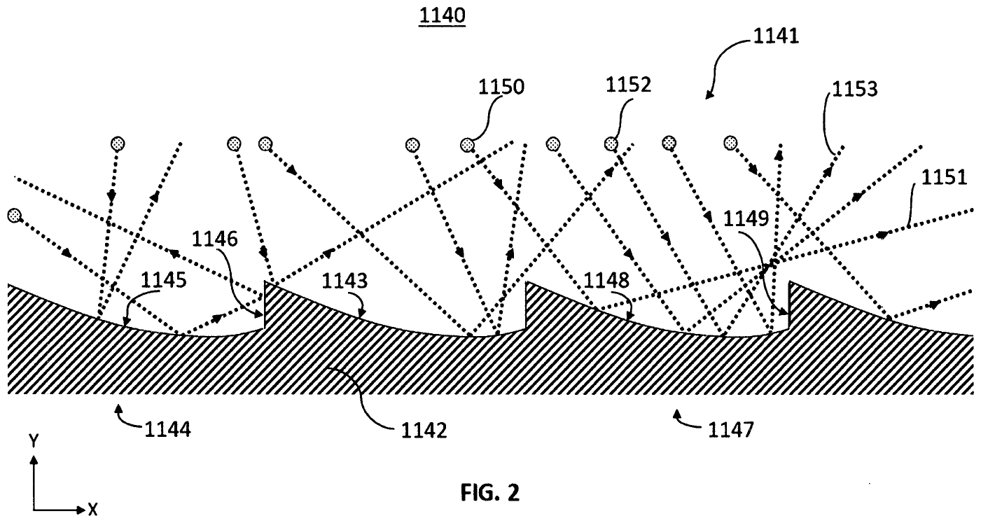

In general, the difference between the average net rate of change of momentum of objects of interest which interact with the filtration system and the average net rate of change of momentum of objects of interest which interact with a baseline filtration system in a baseline scenario has a non-zero component in the positive X-direction. For example, in a, at least initially, static boundary condition, the component of the average net rate of change of momentum of objects of interest which interact with a baseline filtration system in a baseline scenario along the positive X-direction is zero, while the component of the average net rate of change of momentum of objects of interest which interact with the filtration system in FIG. 1 in the positive X-direction is non-zero and positive. In a dynamic boundary condition in which there is a bulk flow of objects of interest in the free stream in the positive X-direction, the component of the average net rate of change of momentum of objects of interest which interact with a baseline filtration system in a baseline scenario along the positive X-direction is non-zero and negative due to the viscous drag associated with the baseline filtration system. In this scenario, the component of the average net rate of change of momentum of objects of interest which interact with the filtration system in FIG. 1 in the positive X-direction can be non-zero and negative, and smaller in magnitude than the same component in the baseline scenario. When the free stream bulk flow of objects of interest is sufficiently small, the component of the average net rate of change of momentum of objects of interest which interact with the filtration system in FIG. 1 in the positive X-direction can be non-zero and positive. In these scenarios, difference between the average net rate of change of momentum of objects of interest which interact with the filtration system and the average net rate of change of momentum of objects of interest which interact with a baseline filtration system in a baseline scenario has a non-zero component in the positive X-direction. This also applies in principle to the embodiments shown in FIGS. 2-5. In FIGS. 6-8 the difference between the average net rate of change of momentum of objects of interest which interact with the filtration system and the average net rate of change of momentum of objects of interest which interact with a baseline filtration system in a baseline scenario has a non-zero component in the negative Y-direction.

In FIG. 1, the inclination angle can be 50 degrees in some embodiments. The inclination angle can be 45 degrees in some embodiments. The inclination angle can be 30 degrees in some embodiments. The inclination angle can be 15 degrees in some embodiments. The inclination angle can be 10 degrees in some embodiments. The inclination angle can be 5 degrees in some embodiments. Note that in some embodiments, or some methods of operation, the bulk flow of OI which is induced by the interaction of OI with the filtering apparatus 1101 can be in the negative X-direction instead of in the positive X-direction.

As a result of a bulk flow induced by the interaction of OI with the surface 1103 of bulk material 1102 of filtering apparatus 1101 in the positive X-direction, there is a net force on filtering apparatus 1101 in the negative X-direction. This force can be employed to do mechanical work, for example. The mechanical work can in turn be converted into electrical work by an electrical generator, for instance. The energy for this work is provided by the thermal energy of OI in the first reservoir 1100. Thus a filtering apparatus 1101 can be employed to convert thermal energy into useful work.

The characteristic dimension of the embodiment shown in FIG. 1 can be considered to be the larger of the two numbers describing the width of a segment and the depth of a segment, for example.

FIG. 2 is a cross-sectional view of one embodiment of the invention. Some features of the apparatus shown in FIG. 2, as well as some of the principles of operation of the apparatus share similarities with the apparatus shown in the other figures, and will therefore not be described in the same detail in the context of FIG. 2, and vice versa.

There is a first reservoir 1140, in which the medium comprises objects of interest, or “OI”, which are schematically represented by individual particles, such as the schematic representation of OI 1150.

The filtering plate 1141 comprises a bulk material 1142, which comprises a first surface 1143. Bulk material 1142 can be made of any suitable material, such as metal, composite, or ceramic. In some embodiments, bulk material 1142 can also be described as a fabric.

In this embodiment surface 1143 comprises segments of surfaces, such as surface 1145 and surface 1146. Surface 1145 is concave in shape, as shown. Surface 1146 is two dimensional and parallel to the YZ-plane in this embodiment. Surface 1143 can be considered to be generated by the extrusion of bulk material 1142 in the positive or negative Z-direction. In other embodiments, the surface 1143 can also be cylindrical or circular in three-dimensional form when viewed in the X-direction. In other embodiments, surface 1143 can also be elliptical, square, or rectangular in form when viewed in the X-direction. In other embodiments, surface 1143 can be in any three dimensional form, provided the principles of operation are maintained.

Surface 1143 comprises several identically configured segments, such as segment 1144 or segment 1147. Each segment can be considered to be a focusing apparatus, or a deflection apparatus, which is configured to deflect or redirect objects of interest which interact with surface 1143 in a desired direction. In embodiment 1141, each segment comprises a first surface, such as first surface 1145 or first surface 1148, and a second surface, such as second surface 1146, or second surface 1149. In FIG. 2, the first surface 1145 is inclined at an angle, such that the surface normal is directed in the positive X-direction and in a plane parallel to the XY-plane. The average angle between the surface normal and the Y-axis is denoted the “inclination angle”. The inclination angle can range from a value greater than zero degrees to a value smaller than ninety degrees. The extent of a segment, such as segment 1144 or segment 1147 along the X-axis, which in this case is also equal to the extent of the first surface along the X-axis, is denoted the “width of a segment”. The “depth of a segment” is the extent of a segment along the Y-axis, which in this case is also equal to the extent of the first surface along the Y-axis. In this embodiment, the second surfaces, such as second surface 1146, is planar in shape and parallel to the YZ-plane.

Examples of interactions between OI and the bulk material 1142 are shown in FIG. 2, as exemplified by trajectory 1153 of OI 1152, or trajectory 1151 of OI 1150. Asa result of the aforementioned inclination angle of the first surfaces, such as first surface 1145 or first surface 1148, the motion of OI after colliding with the first surfaces is preferentially in the positive X-direction.

Note that the type of interaction between the OI and the filtering plate 1141 is a function of the inclination angle and the width of a segment, amongst other parameters such as parameters pertaining to the mean free path of objects of interest in the surrounding medium and the shape of the first and second surfaces, such as first surface 1145 and the second surface 1146. For a certain value of such parameters, the OI which approach the surface 1143 can, on average, experience a net deflection in the positive X-direction in some embodiments. In a dynamic boundary condition, this can lead to a net diffusion, or a bulk flow, of OI in the positive X-direction, for example. Due to the geometry of the surface 1143, the average initial velocity vector of OI can be different to the average final velocity vector of OI. For example, in a hypothetical scenario, such as a scenario in which there is a net motion of the filtering apparatus 1141 relative to the medium in reservoir 1140 in the negative X-direction, the average initial velocity vector of OI can be directed in the positive X-direction and in the negative Y-direction, as shown in FIG. 2. The average final velocity can be directed in the positive X- and Y-direction, where the component in the positive X-direction of the average final velocity is larger than the component in the positive X-direction of the average initial velocity. The non-zero net component in the positive X-direction can lead to a net diffusion or a net acceleration of OI in the positive X-direction.

The inclination angle can be 50 degrees in some embodiments. The inclination angle can be 45 degrees in some embodiments. The inclination angle can be 30 degrees in some embodiments. The inclination angle can be 15 degrees in some embodiments. The inclination angle can be 10 degrees in some embodiments. The inclination angle can be 5 degrees in some embodiments. Note that in some embodiments, or some methods of operation, the bulk flow of OI which is induced by the interaction of OI with the filtering apparatus 1141 can be in the negative X-direction instead of in the positive X-direction.

As a result of a bulk flow induced by the interaction of OI with the surface 1143 of bulk material 1142 of filtering apparatus 1141 in the positive X-direction, there is a net force on filtering apparatus 1141 in the negative X-direction. This force can be employed to do mechanical work, for example. The mechanical work can in turn be converted into electrical work by an electrical generator, for instance. The energy for this work is provided by the thermal energy of OI in the first reservoir 1140. Thus a filtering apparatus 1141 can be employed to convert thermal energy into useful work.

The characteristic dimension of the embodiment shown in FIG. 2 can be considered to be the larger of the two numbers describing the width of a segment and the depth of a segment, for example.

Note that the reflections can be specular or diffuse in this embodiment and embodiments of this type.

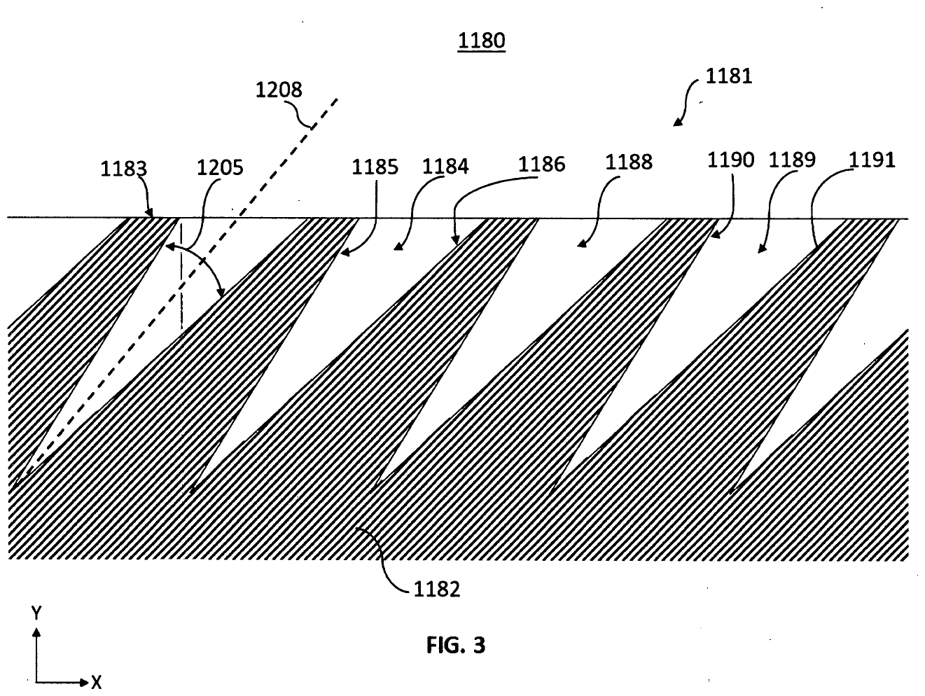

FIG. 3 is a cross-sectional view of one embodiment of the invention. Some features of the apparatus shown in FIG. 3, as well as some of the principles of operation of the apparatus share similarities with the apparatus shown in the other figures, and will therefore not be described in the same detail in the context of FIG. 3, and vice versa.

There is a first reservoir 1180, in which the medium comprises objects of interest, or “OI”.

The filtering plate 1181 comprises a bulk material 1182, which comprises a first surface 1183. Bulk material 1182 can be made of any suitable material, such as metal, composite, or ceramic. In some embodiments, bulk material 1182 can also be described as a fabric.

In this embodiment surface 1183 comprises segments of surfaces, such as surfaces 1185, 1186, 1190, and 1191. Surfaces 1185, 1186, 1190, and 1191 are planar in shape, i.e. two dimensional, in this embodiment. Surface 1183 comprises a top surface, which is parallel to the XZ-plane and planar. Surface 1183 can be considered to be generated by the extrusion of bulk material 1182 in the positive or negative Z-direction in this embodiment. In other embodiments, the surface 1183 can also be cylindrical or circular in three-dimensional form when viewed in the X-direction. In other embodiments, surface 1183 can also be elliptical, square, or rectangular in form when viewed in the X-direction. In other embodiments, surface 1183 can be in any three dimensional form, provided the principles of operation are maintained.

Surface 1183 comprises several identically configured segments, such as segment 1184 or segment 1188, or segment 1189. Each segment can also be described as a slot. Each segment can be considered to be a focusing apparatus, or a deflection apparatus, which is configured to deflect or redirect objects of interest which interact with the segment in a desired direction. In embodiment 1181, each segment comprises a first surface, such as first surface 1185 or first surface 1190, and a second surface, such as second surface 1186, or second surface 1191. In FIG. 3, the first surface 1185 is inclined at an angle, such that the surface normal is directed in the positive X-direction and a negative Y-direction, and such that the surface normal lies in a plane parallel to the XY-plane. The average angle between the surface normal of a first surface and the Y-axis is denoted the “first inclination angle”, which is greater than ninety degrees in this embodiment for surface 1185 or surface 1190. The first inclination angle can range from a value greater than ninety degrees to a value smaller than 180 degrees. In FIG. 3, the second surface 1186 is inclined at an angle, such that the surface normal is directed in the negative X-direction and a positive Y-direction, and such that the surface normal lies in a plane parallel to the XY-plane. The average angle between the surface normal of a second surface and the Y-axis is denoted the “second inclination angle”, which is smaller than ninety degrees in this embodiment for surface 1186 or surface 1191. The second inclination angle can range from a value greater than zero degrees to a value smaller than ninety degrees. The angle between a first surface and a second surface is denoted the “internal angle” 1205. The internal angle can be a value larger than zero and smaller than 180 degrees. In the depicted embodiment, the internal angle is larger than zero and smaller than 45 degrees. In the depicted embodiments, the internal angle is approximately 15 degrees. Dashed line 1208 describes the centroid of a segment.

The first outward surface normal is the outward surface normal of the first surface, such as first surface 1190. The first outward surface normal has a component in the positive X-direction and is directed away from the bulk material. The first inward surface normal is the inward surface normal of the first surface, such as first surface 1190. The first inward surface normal has a component in the negative X-direction and is directed into the bulk material.

The second outward surface normal is the outward surface normal of the second surface, such as second surface 1191. The second outward surface normal has a component in the negative X-direction and is directed away from the bulk material. The second inward surface normal is the inward surface normal of the second surface, such as second surface 1191. The second inward surface normal has a component in the positive X-direction and is directed into the bulk material.

The average outward surface normal is parallel to, and aligned with, the Y-axis in this embodiment. As described, the first outward surface normal has a first inclination angle relative to the average outward surface normal, and the second outward surface normal has a second inclination angle relative to the average outward surface normal. The first inward surface normal has a first inward angle relative to the average outward surface normal, and the second inward surface normal has a second inward angle relative to the average outward surface normal. The “average inclination angle” is the average of the first inclination angle and the second inward angle.

The extent of a segment, such as segment 1184 or segment 1189 along the X-axis, which in this case is also equal to the extent of the second surface along the X-axis, is denoted the “width of a segment”. The “depth of a segment” is the extent of a segment along the Y-axis, which in this case is also equal to the extent of the second surface along the Y-axis.

As a result of the aforementioned inclination angle of the first and second surfaces, such as first surface 1185 or first surface 1190, the motion of OI after colliding with the first or and second surfaces is preferentially in the positive X-direction. In this manner, OI can be deflected or redirected into the positive X-direction as a result of their interaction with the first and second surfaces.

Note that the type of interaction between the OI and the filtering plate 1181 is a function of the first and second inclination angle and the width of a segment, amongst other parameters such as parameters pertaining to the mean free path of objects of interest in the surrounding medium and the shape of the first and second surfaces, such as first surface 1185 and the second surface 1186. For a certain value of such parameters, the OI which approach the surface 1183 can, on average, experience a net deflection in the positive X-direction in some embodiments. In a dynamic boundary condition, this can lead to a net diffusion, or a bulk flow, of OI in the positive X-direction, for example. Due to the geometry of the surface 1183, the average initial velocity vector of OI can be different to the average final velocity vector of OI. For example, in a hypothetical scenario, such as a scenario in which there is a net motion of the filtering apparatus 1181 relative to the medium in reservoir 1180 in the negative X-direction, the average initial velocity vector of OI can be directed in the positive X-direction and in the negative Y-direction. The average final velocity can be directed in the positive X- and Y-direction, where the component in the positive X-direction of the average final velocity is larger than the component in the positive X-direction of the average initial velocity. The non-zero net component in the positive X-direction can lead to a net diffusion or a net acceleration of OI in the positive X-direction.

As a result of a bulk flow induced by the interaction of OI with the surface 1183 of bulk material 1182 of filtering apparatus 1181 in the positive X-direction, there is a net force on filtering apparatus 1181 in the negative X-direction. This force can be employed to do mechanical work, for example. The mechanical work can in turn be converted into electrical work by an electrical generator, for instance. The energy for this work is provided by the thermal energy of OI in the first reservoir 1180. Thus a filtering apparatus 1181 can be employed to convert thermal energy into useful work.

The characteristic dimension of the embodiment shown in FIG. 3 can be considered to be the larger of the two numbers describing the width of a segment and the depth of a segment, for example. In accordance with some embodiments of the invention, the characteristic dimension is smaller than 1000 times the mean free path of OI in an adjacent reservoir.

The width or depth of a segment, or the internal angle, or the first inclination angle and second inclination angle, are examples of parameters concerning the geometry of a segment that can be optimized to maximize an objective subject to constraints. The objective can be the component of the average net rate of change of momentum of objects of interest which interact with the filtration system segment in the positive X-direction, for example. The objective can be the component of the thrust force acting on the filtration system in the negative X-direction, for example. The objective can alternatively be the component of the difference between the average net rate of change of momentum of objects of interest which interact with a baseline filtration system in a baseline scenario and the average net rate of change of momentum of objects of interest which interact with the filtration system in the negative X-direction, for example. The objective can be the component of the difference in the drag acting on a baseline filtration surface in a baseline scenario and the drag acting on the filtration system in the positive X-direction, for example.

Note that the reflections can be specular or diffuse in this embodiment and embodiments of this type.

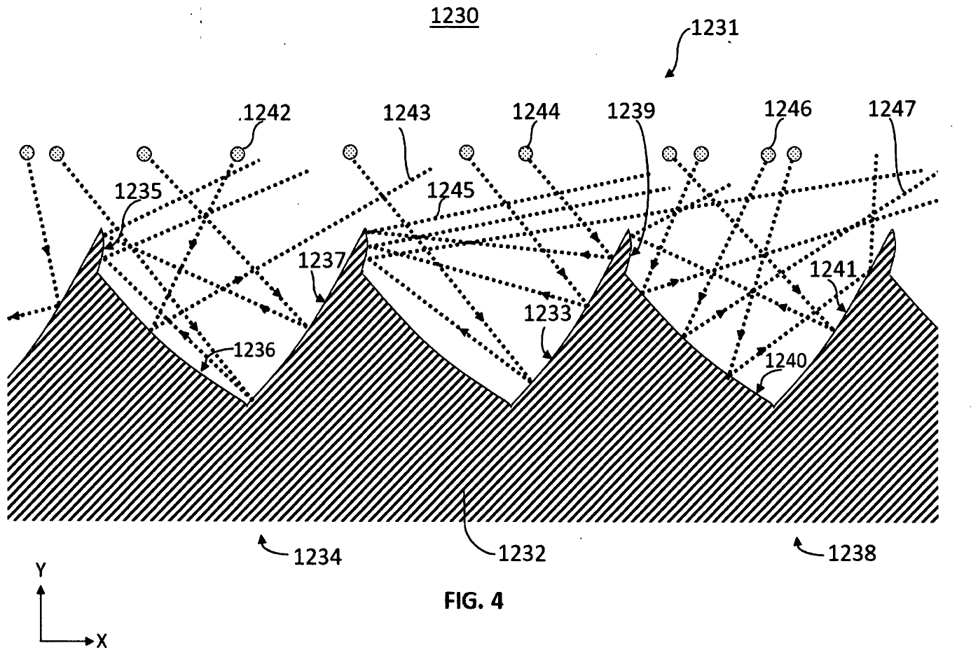

FIG. 4 is a cross-sectional view of one embodiment of the invention. Some features of the apparatus shown in FIG. 4, as well as some of the principles of operation of the apparatus share similarities with the apparatus shown in the other figures, and will therefore not be described in the same detail in the context of FIG. 4, and vice versa.

There is a first reservoir 1230, in which the medium comprises objects of interest, or “OI”.

The filtering plate 1231 comprises a bulk material 1232, which comprises a first surface 1233. Bulk material 1232 can be made of any suitable material, such as metal, composite, or ceramic. In some embodiments, bulk material 1232 can also be described as a fabric.

In this embodiment surface 1233 comprises segments of surfaces, such as surfaces 1235, 1236, 1237, 1239, 1240, and 1241. Surface 1233 can be considered to be generated by the extrusion of bulk material 1232 in the positive or negative Z-direction in this embodiment. In other embodiments, the surface 1233 can also be cylindrical or circular in three-dimensional form when viewed in the X-direction. In other embodiments, surface 1233 can also be elliptical, square, or rectangular in form when viewed in the X-direction. In other embodiments, surface 1233 can be in any three dimensional form, provided the principles of operation are maintained.

Surface 1233 comprises several identically configured segments, such as segment 1234, which comprises surfaces 1235, 1236, and 1237, or segment 1238, which comprises surfaces 1239, 1240, and 1241. Each segment can also be described as a slot. Each segment can be considered to be a focusing apparatus, or a deflection apparatus, which is configured to deflect or redirect objects of interest which interact with the segment in a desired direction. In embodiment 1231, each segment comprises a first surface, such as first surface 1235 or first surface 1239, and a second surface, such as second surface 1236, or second surface 1240, as well as a third surface, such as third surface 1237, or third surface 1241.

The first surface, such as first surface 1235 is convex in shape in this embodiment. The second surface, such as second surface 1236 is concave in shape in this embodiment. The third surface, such as third surface 1237 is concave in shape in this embodiment. The third surface is configured to focus a portion of trajectories of OI onto the first surface, which is configured to defocus and redirect the trajectories of OI into the positive X-direction. The second surface is configured to focus and redirect the trajectories of OI into the positive X-direction. In other embodiments, concave surfaces can be planar or convex, and convex surfaces can be planar or concave, provided that the general principles of operation, i.e. the redirection of trajectories of OI into the positive X-direction, are maintained.

In FIG. 4, the first surface, such as first surfaces 1235, is inclined at an angle, such that the surface normal is directed substantially in the positive X-direction, and such that the surface normal lies in a plane parallel to the XY-plane. In other embodiments, the surface normal need not lie in a plane parallel to the XY-plane. The average angle between the surface normal of a first surface and the Y-axis is denoted the “first inclination angle”, which is approximately ninety degrees in this embodiment for surface 1235 or surface 1239. The first inclination angle can range from a value greater than zero degrees to a value smaller than approximately 135 degrees.

In FIG. 4, the second surface 1236 is inclined at an angle, such that the surface normal is directed in the positive X-direction and a positive Y-direction, and such that the surface normal lies in a plane parallel to the XY-plane. In other embodiments, the surface normal need not lie in a plane parallel to the XY-plane. The average angle between the surface normal of a second surface and the Y-axis is denoted the “second inclination angle”, which is smaller than ninety degrees in this embodiment for surface 1186 or surface 1191. The second inclination angle can range from a value greater than zero degrees to a value smaller than ninety degrees.

In FIG. 4, the third surface 1237 is inclined at an angle, such that the surface normal is directed in the negative X-direction and a positive Y-direction, and such that the surface normal lies in a plane parallel to the XY-plane. In other embodiments, the surface normal need not lie in a plane parallel to the XY-plane. For example, the third surface can be concave when viewed in the negative Y-direction in order to enhance the focusing effect onto the first surface in the XZ-plane. The average angle between the surface normal of a third surface and the Y-axis is denoted the “third inclination angle”, which is smaller than ninety degrees in this embodiment for surface 1237 or surface 1241. The third inclination angle can range from a value greater than zero degrees to a value smaller than ninety degrees.

The extent of a segment, such as segment 1234 or segment 1238 along the X-axis, is denoted the “width of a segment”, which is equal to the extent of the combined surface of the first, second, and third surfaces along the X-axis. The “depth of a segment” is the extent of a segment along the Y-axis, which in this case is equal to the extent of the third surface along the Y-axis, or the extent of the combined first and second surface along the Y-axis.

Examples of interactions between OI and the bulk material 1232 are shown in FIG. 4, as exemplified by trajectory 1243 of OI 1242, or trajectory 1245 of OI 1244, or trajectory 1247 of OI 1246. As a result of the aforementioned configuration of the first, second, and third surfaces in a segment, the motion of OI after colliding with the first, second, or third surfaces is preferentially in the positive X-direction. In this manner, OI can be deflected or redirected into the positive X-direction as a result of their interaction with the first, second, or third surfaces.

Note that the type of interaction between the OI and the filtering plate 1231 is a function of the first, second, and third inclination angle, the shape of the first, second, and third surfaces, and the width and depth of a segment, amongst other parameters such as parameters pertaining to the mean free path of objects of interest in the surrounding medium. For a certain value of such parameters, the OI which approach the surface 1233 can, on average, experience a net deflection in the positive X-direction in some embodiments. In a dynamic boundary condition, this can lead to a net diffusion, or a bulk flow, of OI in the positive X-direction, for example. Due to the geometry of the surface 1233, the average initial velocity vector of OI can be different to the average final velocity vector of OI. For example, in a hypothetical scenario, such as a scenario in which there is a net motion of the filtering apparatus 1231 relative to the medium in reservoir 1230 in the negative X-direction, the average initial velocity vector of OI can be directed in the positive X-direction and in the negative Y-direction. The average final velocity can be directed in the positive X- and Y-direction, where the component in the positive X-direction of the average final velocity is larger than the component in the positive X-direction of the average initial velocity. The non-zero net component in the positive X-direction can lead to a net diffusion or a net acceleration of OI in the positive X-direction.

As a result of a bulk flow induced by the interaction of OI with the surface 1233 of bulk material 1232 of filtering apparatus 1231 in the positive X-direction, there is a net force on filtering apparatus 1231 in the negative X-direction. This force can be employed to do mechanical work, for example. The mechanical work can in turn be converted into electrical work by an electrical generator, for instance. The energy for this work is provided by the thermal energy of OI in the first reservoir 1230. Thus a filtering apparatus 1231 can be employed to convert thermal energy into useful work.

The characteristic dimension of the embodiment shown in FIG. 4 can be considered to be the larger of the two numbers describing the width of a segment and the depth of a segment, for example. In accordance with some embodiments of the invention, the characteristic dimension is smaller than 1000 times the mean free path of OI in an adjacent reservoir.

Note that the reflections can be specular or diffuse in this embodiment and embodiments of this type.

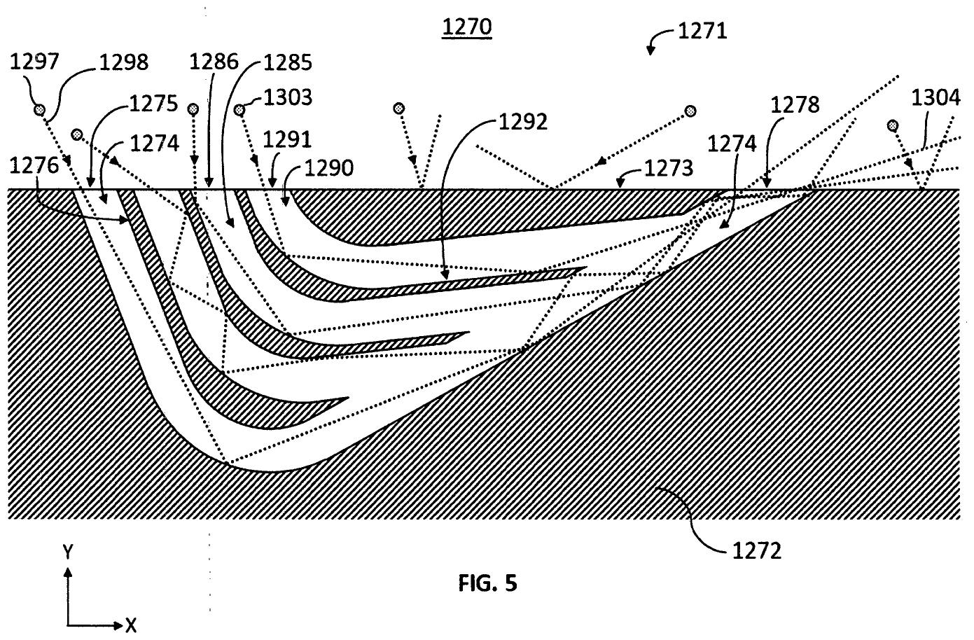

FIG. 5 is a cross-sectional view of one embodiment of the invention. Some features of the apparatus shown in FIG. 5, as well as some of the principles of operation of the apparatus share similarities with the apparatus shown in the other figures, and will therefore not be described in the same detail in the context of FIG. 5, and vice versa.

There is a first reservoir 1270, in which the medium comprises objects of interest, or “OI”.

The filtering plate 1271 comprises a bulk material 1272, which comprises a first surface 1273. Bulk material 1272 can be made of any suitable material, such as metal, composite, or ceramic. In some embodiments, bulk material 1272 can also be described as a fabric.

Surface 1273 comprises several identically configured channel systems, with each channel system comprising a plurality of channels, such as channel 1274, channel 1285, or channel 1290. Each channel comprises a first opening, such as first opening 1275 of channel 1274, first opening 1286 of channel 1285, or first opening 1291 of channel 1290, and a second opening, such as second opening 1278 of channels 1274, 1285, or 1290. Each channel also comprises an interior surface, such as interior surface 1276, or interior surface 1292.

Each channel system can be considered to be a focusing apparatus, or a deflection apparatus, which is configured to deflect or redirect objects of interest which interact with the channel system in a desired direction. As shown in FIG. 5, several channels of a channel system merge into a single channel 1247 within the channel system. Note that a channel system can comprise more than 4 channels merging into a single channel. For instance, a channel system can comprise several more channels offset relative to each other in the XZ-plane, where each channel merges into a single channel 1247. For instance 20 channels can merge into a single channel. In another example, 30 channels can merge into a single channel. The single channel into which several channels merge, such as channel 1274, is denoted the “main channel”. The geometry or shape of each channel is configured to focus a portion of trajectories of OI into the main channel.

The extent of a channel system along the X-axis, is denoted the “width of a channel system”, which is equal to the extent of the channel 1274 along the X-axis. The “depth of a channel system” is the extent of a channel system along the Y-axis, which in this case is equal to the extent of channel 1274 along the Y-axis.

Examples of interactions between OI and the bulk material 1272 are shown in FIG. 5, as exemplified by trajectory 1298 of OI 1297, or trajectory 1304 of OI 1203, for example. As a result of the aforementioned configuration of the channels in a channel system, the motion of OI after interacting with a channel system is preferentially in the positive X-direction. In this manner, OI can be deflected or redirected into the positive X-direction as a result of their interaction with the channels in a channel system.

Note that the type of interaction between the OI and the filtering plate 1271 is a function of the shape of the channels in a channel system, as well as the width and depth of a channel system, amongst other parameters such as parameters pertaining to the mean free path of objects of interest in the surrounding medium. For a certain value of such parameters, the OI which approach the surface 1273 can, on average, experience a net deflection in the positive X-direction in some embodiments. In a dynamic boundary condition, this can lead to a net diffusion, or a bulk flow, of OI in the positive X-direction, for example. Due to the geometry of the channel system, the average initial velocity vector of OI can be different to the average final velocity vector of OI. For example, in a hypothetical scenario, such as a scenario in which there is a net motion of the filtering apparatus 1271 relative to the medium in reservoir 1270 in the negative X-direction, the average initial velocity vector of OI can be directed in the positive X-direction and in the negative Y-direction. The average final velocity can be directed in the positive X- and Y-direction, where the component in the positive X-direction of the average final velocity is larger than the component in the positive X-direction of the average initial velocity. The non-zero net component in the positive X-direction can lead to a net diffusion or a net acceleration of OI in the positive X-direction.

As a result of a bulk flow induced by the interaction of OI with the surface 1273 of bulk material 1272 of filtering apparatus 1271 in the positive X-direction, there is a net force on filtering apparatus 1271 in the negative X-direction. This force can be employed to do mechanical work, for example. The mechanical work can in turn be converted into electrical work by an electrical generator, for instance. The energy for this work is provided by the thermal energy of OI in the first reservoir 1270. Thus a filtering apparatus 1271 can be employed to convert thermal energy into useful work.

The characteristic dimension of the embodiment shown in FIG. 5 can be considered to be the larger of the two numbers describing the width of a channel system and the depth of a channel system, for example. The characteristic dimension of the embodiment shown in FIG. 5 can also be considered to be the length of the main channel, such as channel 1274, of a channel system. In accordance with some embodiments of the invention, the characteristic dimension is smaller than 1000 times the mean free path of OI in an adjacent reservoir.

Note that the reflections can be specular or diffuse in this embodiment and embodiments of this type.

FIG. 6 is a cross-sectional view of one embodiment of the invention. Some features of the apparatus shown in FIG. 6, as well as some of the principles of operation of the apparatus share similarities with the apparatus shown in the other figures, and will therefore not be described in the same detail in the context of FIG. 6, and vice versa.

There is a first reservoir 1330 and a second reservoir 1331 in which the medium comprises objects of interest, or “OI”.

The filtering plate 1332 comprises a bulk material 1335, which comprises a first surface 1333 and a second surface 1334. Bulk material 1335 can be made of any suitable material, such as metal, composite, or ceramic. In some embodiments, bulk material 1335 can also be described as a fabric.

The filtering plate 1332 also comprises several channels or channel systems, such as channel 1336, 1351, 1352, or channel 1353. Each channel comprises a first opening, such as first opening 1337, and a second opening, such as second opening 1338. Each channel comprises several segments, such as segment 1339, or segment 1343, or segment 1347, or segment 1349 in channel system 1336. Each channel segment comprises a first interior surface, such as first interior surface 1340 of segment 1339, or first interior surface 1344 of segment 1343. Each channel segment comprises a second interior surface, such as second interior surface 1341 of segment 1339, or second interior surface 1345 of segment 1343. Each segment also comprises a first opening, such as first opening 1337 of segment 1339, and a second opening, such as second opening 1342 of segment 1339. The second opening 1342 of segment 1339 is identical to the first opening 1342 of segment 1343. Each segment is axially symmetric, such that first surfaces, such as first surface 1340, is in the shape of a tapered cylinder or cone, and such that the second surfaces, such as second surface 1341 is in the shape of a planar annular circle. The cross-sectional area of a channel, such as channel 1336 or channel 1352, is circular in shape when viewed in the negative Y-direction. In other embodiments the cross-sectional geometry of a channel when viewed in the negative Y-direction can be square, rectangular, polygonal, or elliptical, for example.

In FIG. 6, the first interior surface 1340 is inclined at an angle, such that the surface normal has a component in the negative Y-direction. Recall that the first interior surface 1340 is axially symmetric about a central axis parallel to the Y-axis in this embodiment. The average angle between the surface normal of a first interior surface and the Y-axis is denoted the “first inclination angle”, which is greater than ninety degrees in this embodiment for first interior surface 1340 or first interior surface 1344. The first inclination angle can range from a value greater than ninety degrees to a value smaller than 180 degrees. The first inclination angle can be 120 degrees, for example. The first inclination angle can be 105 degrees, for example. The first inclination angle can be 150 degrees, for example.

In FIG. 6, the second interior surface 1341 is configured such that the surface normal is directed in the positive Y-direction. The average angle between the surface normal of a second interior surface and the Y-axis is denoted the “second inclination angle”, which is zero degrees in this embodiment for surface 1341 or surface 1345. The second inclination angle can range from a value greater than or equal to zero degrees to a value smaller than ninety degrees. The second inclination angle can be zero degrees, for example. The second inclination angle can be 10 degrees, for example.

The extent of the first interior surface along the Y-axis is denoted the “first extent”, and the extent of the second interior surface along the Y-axis is denoted the “second extent”. In typical embodiments, the first extent is larger in magnitude than the second extent.

The extent of a channel segment along the X-axis, is denoted the “width of a channel segment”. The “depth of a channel segment” is the extent of a channel segment along the Y-axis.

The first interior surface can be considered to focus or preferentially transmit OI through the second opening of a channel segment, such as second opening 1342, compared to through the first opening of a channel segment, such as first opening 1337. As a result of the aforementioned geometry and a sufficiently small size of the channels, the motion of OI after interacting with a channel is preferentially in the negative Y-direction. In this manner, OI can be deflected or redirected into the negative Y-direction as a result of their interaction with the channel segments. OI thus preferentially diffuse through a channel in the negative Y-direction from the first reservoir 1330 into the second reservoir 1331 as opposed to in the positive Y-direction from the second reservoir 1331 into the first reservoir 1330.

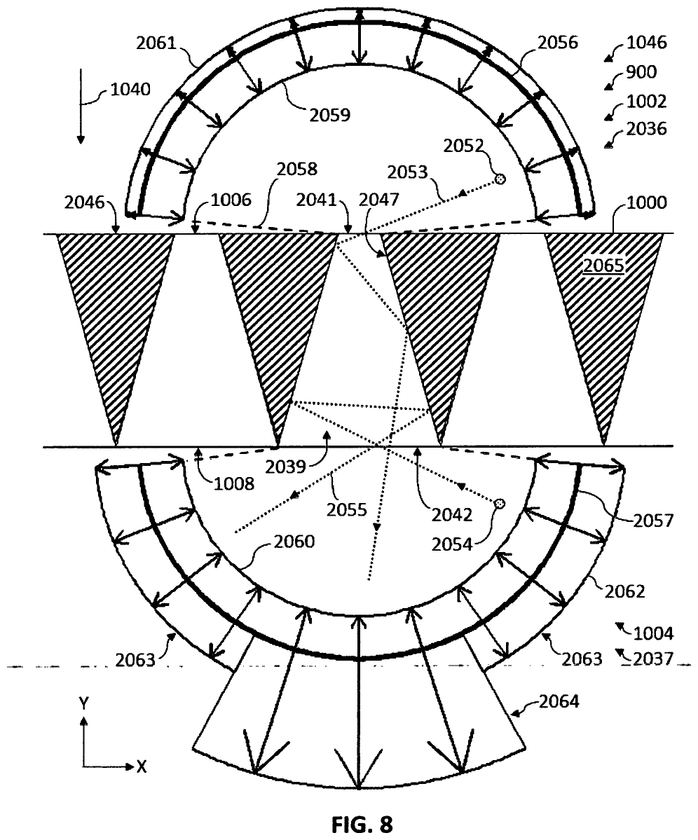

The focusing effect is described in more detail in the context of FIG. 8. The configuration of a channel segment of the embodiment shown in FIG. 6 can be considered to be similar to the configuration of a single channel of the embodiment shown in FIG. 8. The embodiments shown in FIG. 6 can be considered to be an arrangement of several embodiments shown in FIG. 8 arranged in series, where the second opening 2042 of one channel overlaps with the first opening 2041 of a second channel, and where each channel in FIG. 8 forms a channel segment in FIG. 6.

In other embodiments the diameter of the cross-section of the first interior surface viewed along the Y-axis can increase at a decreasing rate in the negative Y-direction, resulting in a concave first interior surface. This can enhance the focusing effect of OI in the negative Y-direction. Also within the scope of the invention are embodiments in which the diameter of the cross-section of the first interior surface viewed along the Y-axis increase at an increasing rate in the negative Y-direction, resulting in a convex first interior surface.

Note that the type of interaction between the OI and the filtering plate 1332 is a function of the shape of the channels, as well as the width and depth of a channel, amongst other parameters such as parameters pertaining to the mean free path of objects of interest in the surrounding medium. For a certain value of such parameters, the OI which approach the surface 1333 or surface 1334 can, on average, experience a net deflection in the negative Y-direction in some embodiments.

The “first transmissivity” is the probability of an OI diffusing into the second reservoir 1331 after entering a channel from the first reservoir 1330. The “second transmissivity” is the probability of an OI diffusing into the first reservoir 1330 after entering a channel from the second reservoir 1331. Due to the geometry and sufficiently small size of the channel segments, the first transmissivity is larger than the second transmissivity.

In a static boundary condition, this can lead to an increase in the concentration of OI in the second reservoir 1331 compared to the first reservoir 1330. The filter plate 1332 can thus be employed in pumping applications.

In a dynamic boundary condition, this can lead to a net diffusion, or a bulk flow, of OI in the negative Y-direction, for example. Due to the geometry of the channel, the average initial velocity vector of OI can be different to the average final velocity vector of OI. For example, in a hypothetical scenario, such as a scenario in which there is a net motion of the filtering apparatus 1332 relative to the medium in reservoir 1330 in the positive Y-direction, the average initial net velocity vector of OI can be directed in the negative Y-direction. The average final velocity can be directed in the negative Y-direction, where the component in the negative Y-direction of the average final velocity is larger than the component in the negative Y-direction of the average initial velocity. The non-zero net component in the negative Y-direction can lead to a net diffusion or a net acceleration of OI in the negative Y-direction.

As a result of a bulk flow induced by the interaction of OI with the surfaces of filtering apparatus 1332 in the negative Y-direction, there is a net force on filtering apparatus 1332 in the positive Y-direction. This force can be employed to do mechanical work, for example. The mechanical work can in turn be converted into electrical work by an electrical generator, for instance. The energy for this work is provided by the thermal energy of OI in the first reservoir 1330 or the second reservoir 1331. Thus a filtering apparatus 1332 can be employed to convert thermal energy into useful work.

The characteristic dimension of the embodiment shown in FIG. 6 can be considered to be the larger of the two numbers describing the width of a channel segment and the depth of a channel segment, for example. In accordance with some embodiments of the invention, the characteristic dimension is smaller than 1000 times the mean free path of OI in an adjacent reservoir.

The embodiment shown in FIG. 6 can be considered to be similar to the embodiment shown in FIG. 1, where the surface 1103 can also be cylindrical or circular in three-dimensional form, and where both the width of a channel segment and the depth of a channel segment are smaller than 1000 times the mean free path of OI in an adjacent reservoir.

Note that the reflections can be specular or diffuse in this embodiment and embodiments of this type.

FIG. 7 is a cross-sectional view of one embodiment of the invention. Some features of the apparatus shown in FIG. 7, as well as some of the principles of operation of the apparatus share similarities with the apparatus shown in the other figures, and will therefore not be described in the same detail in the context of FIG. 7, and vice versa.

There is a first reservoir 1400 and a second reservoir 1401 in which the medium comprises objects of interest, or “OI”.

The filtering plate 1402 comprises a bulk material 1405, which comprises a first surface 1403 and a second surface 1404. Bulk material 1405 can be made of any suitable material, such as metal, composite, or ceramic. In some embodiments, bulk material 1405 can also be described as a fabric.

The filtering plate 1402 also comprises several channels or channel systems, such as channel 1406, or channel 1421. Each channel comprises a first opening, such as first opening 1407 or first opening 1422, and a second opening, such as second opening 1408 or second opening 1423. Each channel comprises several segments, such as segment 1409, or segment 1413, or segment 1417, or segment 1419 in channel system 1406. Each channel segment comprises a first interior surface, such as first interior surface 1410 of segment 1409. Each channel segment comprises a second interior surface, such as second interior surface 1411 of segment 1409. Each segment also comprises a first opening, such as first opening 1407 of segment 1409, and a second opening, such as second opening 1412 of segment 1409. The second opening 1412 of segment 1409 is identical to the first opening 1412 of segment 1413. Each segment is axially symmetric, such that first surfaces, such as first surface 1410, is in the shape of a tapered cylinder or cone, and such that the second surfaces, such as second surface 1411 is in the shape of a planar annular circle. The cross-sectional area of a channel, such as channel 1406 or channel 1421, is circular in shape when viewed in the negative Y-direction. In other embodiments the cross-sectional geometry of a channel when viewed in the negative Y-direction can be square, rectangular, polygonal, or elliptical, for example.

In FIG. 7, the first interior surface 1410 is inclined at an angle, such that the surface normal has a component in the negative Y-direction. Recall that the first interior surface 1410 is axially symmetric about a central axis parallel to the Y-axis in this embodiment. The average angle between the surface normal of a first interior surface and the Y-axis is denoted the “first inclination angle”, which is greater than ninety degrees in this embodiment. The first inclination angle can range from a value greater than ninety degrees to a value smaller than 180 degrees. The first inclination angle can be 120 degrees, for example. The first inclination angle can be 105 degrees, for example. The first inclination angle can be 150 degrees, for example.

In FIG. 7, the second interior surface 1411 is configured such that the surface normal is directed in the positive Y-direction. The average angle between the surface normal of a second interior surface and the Y-axis is denoted the “second inclination angle”, which is zero degrees in this embodiment for surface 1411. The second inclination angle can range from a value greater than or equal to zero degrees to a value smaller than ninety degrees. The second inclination angle can be zero degrees, for example. The second inclination angle can be 10 degrees, for example.

The extent of the first interior surface along the Y-axis is denoted the “first extent”, and the extent of the second interior surface along the Y-axis is denoted the “second extent”. In typical embodiments, the first extent is larger in magnitude than the second extent.

The extent of a channel segment along the X-axis, is denoted the “width of a channel segment”. The “depth of a channel segment” is the extent of a channel segment along the Y-axis. The extent of the first interior surface along the X-direction, or the extent of the second interior surface along the X-direction, is denoted the “thickness of a channel segment”. The thickness of a channel segment in the context of FIG. 7 is analogous to the depth of a channel segment in the context of FIG. 1. The depth of a channel segment in the context of FIG. 7 is analogous to the width of a channel segment in the context of FIG. 1.

The first interior surface can be considered to preferentially direct OI in the negative Y-direction. As a result of the aforementioned geometry and a sufficiently small size of the depth and thickness of a channel segment, the motion of OI after interacting with a channel is preferentially in the negative Y-direction. This is similar to the interaction between OI and the bulk material 1102 in FIG. 1, where the OI which approach the surface 1103 can, on average, experience a net deflection in the positive X-direction in some embodiments. For the embodiment shown in FIG. 7, for a dynamic boundary condition, this can lead to a net diffusion, or a bulk flow, of OI in the negative Y-direction. OI thus preferentially diffuse through a channel in the negative Y-direction from the first reservoir 1400 into the second reservoir 1401 as opposed to in the positive Y-direction from the second reservoir 1401 into the first reservoir 1400.

In other embodiments the diameter of the cross-section of the first interior surface viewed along the Y-axis can increase at a decreasing rate in the negative Y-direction, resulting in a concave first interior surface. This can enhance the focusing effect of OI in the negative Y-direction, as explained in more detail in the context of FIG. 2. Also within the scope of the invention are embodiments in which the diameter of the cross-section of the first interior surface viewed along the Y-axis increase at an increasing rate in the negative Y-direction, resulting in a convex first interior surface.

As mentioned, the interior surface of channel 1406 or channel 1421 is configured similarly to the embodiment 1101 shown in FIG. 1. Similarly, in other embodiments, the interior surface of channel 1406 can be configured similarly to the embodiment 1141 shown in FIG. 2. In other embodiments, the interior surface of channel 1406 can be configured similarly to the embodiment 1181 shown in FIG. 3. In other embodiments, the interior surface of channel 1406 can be configured similarly to the embodiment 1231 shown in FIG. 4. In other embodiments, the interior surface of channel 1406 can be configured similarly to the embodiment 1271 shown in FIG. 5. Due to the parallel arrangement of channels it is possible to convert the shear force exerted by OI on the channel walls into an axial force. By specially configuring the geometry of the interior walls of a channel, the lateral forces or shear forces on a channel wall can be combined into an axial thrust force on a plate, such as plate 1402, in the positive Y-direction.

Note that the type of interaction between the OI and the filtering plate 1402 is a function of the shape of the channels, as well as the width and depth of a channel, amongst other parameters such as parameters pertaining to the mean free path of objects of interest in the surrounding medium. For a certain value of such parameters, the OI which approach the surface 1403 or surface 1404 can, on average, experience a net deflection in the negative Y-direction in some embodiments.

The “first transmissivity” is the probability of an OI diffusing into the second reservoir 1401 after entering a channel from the first reservoir 1400. The “second transmissivity” is the probability of an OI diffusing into the first reservoir 1400 after entering a channel from the second reservoir 1401. Due to the geometry and sufficiently small size of the channel segments, the first transmissivity is larger than the second transmissivity.

In a dynamic boundary condition, this can lead to a net diffusion, or a bulk flow, of OI in the negative Y-direction, for example. Due to the geometry of the channel, the average initial velocity vector of OI can be different to the average final velocity vector of OI. For example, in a hypothetical scenario, such as a scenario in which there is a net motion of the filtering apparatus 1402 relative to the medium in reservoir 1400 in the positive Y-direction, the average initial net velocity vector of OI can be directed in the negative Y-direction. The average final velocity can be directed in the negative Y-direction, where the component in the negative Y-direction of the average final velocity is larger than the component in the negative Y-direction of the average initial velocity. The non-zero net component in the negative Y-direction can lead to a net diffusion or a net acceleration of OI in the negative Y-direction.

As a result of a bulk flow induced by the interaction of OI with the surfaces of filtering apparatus 1402 in the negative Y-direction, there is a net force on filtering apparatus 1402 in the positive Y-direction. This force can be employed to do mechanical work, for example. The mechanical work can in turn be converted into electrical work by an electrical generator, for instance. The energy for this work is provided by the thermal energy of OI in the first reservoir 1400 or the second reservoir 1401. Thus a filtering apparatus 1402 can be employed to convert thermal energy into useful work.

The characteristic dimension of the embodiment shown in FIG. 6 can be considered to be the larger of the two numbers describing the thickness of a channel segment and the depth of a channel segment, for example. In accordance with some embodiments of the invention, the characteristic dimension is smaller than 1000 times the mean free path of OI in an adjacent reservoir.

The embodiment shown in FIG. 7 can be considered to be similar to the embodiment shown in FIG. 1, where the surface 1103 can also be cylindrical or circular in three-dimensional form, and where the depth and thickness of a channel segment is smaller than 1000 times the mean free path of OI in an adjacent reservoir.

Note that the width of a channel segment in FIG. 7 can be larger than 1000 times the mean free path of OI in an adjacent reservoir. The maximum width or length of a channel in the embodiment shown in FIG. 7, such as channel 1406, need not be constrained to a value which is smaller than about 1000 times the mean free path of an object of interest in an adjacent reservoir. This is due to the interior channel walls, such as surfaces 1410 and 1411, of channel 1406 being configured in a similar manner as the surfaces of the embodiment shown in FIG. 1, such as surface 1108 or surface 1109. As such, surfaces 1410 and 1411 can be considered to be distinct focusing apparatuses in the first reservoir 1400, which also extends into channel 1406. In other words, in the limit in which the width of channel 1406 is sufficiently large, the interior surface of channel 1406 can be modeled or considered to interact with the objects of interest within the channel 1406 in a similar manner as the filtering plate 1101 interacts with objects of interest in the first reservoir 1100 in FIG. 1. For instance, the width of channel 1406 can be one million mean free paths of objects of interest in channel 1406 in some embodiments. In another example, the width of channel 1406 can be 10,000 mean free paths of objects of interest in channel 1406 or an adjacent reservoir in some embodiments.

Note that the reflections can be specular or diffuse in this embodiment and embodiments of this type.

FIG. 8 is a cross-sectional view of one embodiment of the invention and a schematic representation of the interaction of said embodiment with objects of interest.

In FIG. 8 the distribution of initial directions, i.e. the distribution of the directions of the initial velocities of OI which interact with the filtering apparatus 900, are uniformly distributed over the range of all angles, i.e. 360 degrees. In the simplified scenario shown in FIG. 8, the distribution of initial directions for OI which enter a channel from the first reservoir 2036 is uniform. This is indicated by the uniformly distributed incident flux 2059 from the first reservoir, where the distribution is uniform over the range of possible directions indicated by the arrows within the contours of the plot of the incident flux 2059. The incident flux 2059 is measured relative to the reference line 2056. For the dynamic boundary condition the properties of the first reservoir 2036 and the second reservoir 2037 are assumed to be instantaneously identical. Accordingly, the distribution of incident flux 2060 of OI from the second reservoir 2037 as a function of the direction of the incident velocity is also uniform over all directions, as indicated by a constant magnitude of flux 2060 relative to reference line 2057.

Such a distribution of incident flux occurs in a wide variety of applications of embodiments of the invention. For example, in a typical stationary medium, i.e. a medium in which the average velocity of OI is zero, i.e. a medium in which the bulk flow is zero, the distribution of velocities of OI is uniformly distributed over all angles. This applies to atoms or molecules in gases, or electrons in the conduction bands of conductors. A filtering apparatus placed in such a stationary medium will therefore be subject to a uniform distribution of initial directions, i.e. the probability of an OI interacting with a channel or an outside surface of a filtering apparatus having an initial velocity with a specified direction is approximately equal for all directions.

For the simplified embodiment shown in FIG. 8, all of the OI which enter a channel such as channel 2039 from the first reservoir 2036 and transmitted to the second reservoir. Note that, for simplicity, it is assumed that there are no randomizing scattering events throughout the motion of an OI through the filtering apparatus. In other embodiments there can be scattering events, such as OI to OI collisions or diffuse reflections from the interior surface of a channel, such as interior surface 2047, provided that there can still be a net diffusion for a dynamic boundary condition or a net concentration, pressure, or density difference for a static boundary condition. As an OI diffuses from the first reservoir 2036 to the second reservoir 2037 through channel 2039, an OI can collide with the interior wall 2047 of a channel. Due to the angle of the wall relative to the XZ-plane, the component of the direction of motion of an OI along the Y-direction increases. This effect is shown in FIG. 8 in terms of the example trajectory of an OI, such as trajectory 2053 of OI 2052. As shown, the component of motion or of the velocity of OI 2052 in the negative Y-direction increases in magnitude with each collision with the interior surface 2047. As a result, the initially uniform distribution of velocities in the first reservoir 2036 indicated by flux magnitude 2059 as a function of direction is no longer uniform when the OI arrive in the second reservoir 2037. The initially hemispherical, uniform distribution of directions has been focused into a concentrated beam 2064 of outflow velocities. Due to the high first transmissivity and the geometric properties of the interior surface 2047 of channel 2039 the entire influx 2059, i.e. the influx 2059 integrated over all angles, has been focused into a reduced set of angles, i.e. a concentrated beam 2064.

Conversely, any influx 2060 from the second reservoir 2037 into channel 2039 with an initial angle which lies within the limited range of said beam 2064 is spread out over the entire range of possible influx angles, resulting in a reduced outflux magnitude 2061, measured relative to the same reference line 2056. Any influx 2060 from the second reservoir into channel 2039 with an initial angle which lies outside the limited range of said beam 2064 is reflected back into the second reservoir 2037, as indicated by the portion 2063 of outflux 2062 which lies outside of beam 2064. Oufflux 2062 is also measured relative to reference line 2057. The scenario in which an OI from the second reservoir 2037 is reflected back into the second reservoir 2037 is exemplified by trajectory 2055 of OI 2054.

As a result, the first transmissivity is larger than the second transmissivity. In some embodiments, the ratio of the first transmissivity to the second transmissivity is sufficiently large, that the ratio of the product of the first transmissivity and the first capture area, i.e. the area of first opening 2041 in the XZ-plane, to the product of the second transmissivity and the second capture area, i.e. the area of the second opening 2042, is greater than one, despite the first capture area being smaller than the second capture area. In some such embodiments, therefore, there is a net diffusion of OI from the first reservoir 2036 to the second reservoir 2037 for a dynamic boundary condition, or a larger concentration, density, or pressure of OI in the second reservoir 2037 relative to the first reservoir 2036 for a static boundary condition.

For a dynamic boundary condition, there is a net flow 1040 of objects of interest through the filtering apparatus 900, or 1000, from the first reservoir 2036 into the second reservoir 2037. The filtering apparatus 900 comprises a bulk material 2065, a first surface 2046, several channels, such as channel 2039, each channel comprising a first opening 2041 or 1006 and a second opening 2042 or 1008 and an interior surface 2047. In the depicted embodiment, the majority of interactions between the objects of interest and the boundaries of the channel, i.e. the interior surface 2047, can be described as specular reflections. In some such embodiments, more than 50% of said interactions can be described as specular reflections. In some such embodiments, more than 90% of said interactions can be described as specular reflections. In some such embodiments, more than 30% of said interactions can be described as specular reflections.

Note that the effective aperture of first opening 2041 to the second reservoir 2037 is described by the cross-sectional area of beam 2064 along the length of the beam, which is cone shaped in this example. The effective aperture of first opening 2041 to the first reservoir 2036 is described by the cross-sectional area of outflux 2061, which is almost hemispherical in this example. For the dynamic boundary condition, therefore, the aperture in the second reservoir is smaller than the aperture in the first reservoir, resulting in a net diffusion of OI from the first reservoir to the second reservoir.

The “width” of a channel is the maximum collisional diameter of a theoretical, spherical object of interest which is able to diffuse through the channel. Note that the width of a channel can be different to the characteristic width of a focusing apparatus, or the characteristic width of a channel segment.

The average “length” of a channel, or the average length of a channel system, is the length of the line which describes the centroid of a channel between the openings of the channel, where the openings refer to the interface between the channel and a reservoir. A single point on the centroid describes the center of the cross-sectional area of a channel at the location of the point, where the cross-sectional area is measured on a plane perpendicular to the local average direction of diffusion of objects of interest through a channel, i.e. perpendicular to the local axis along the length of the channel. For example, the cross-sectional area of a point within channel 1336 is measured along a plane parallel to the XZ-plane. Since the channels in the depicted channel system have a circular cross-section in general, the centroid of the channels is the line describing the centers of the circles describing the cross-sections of each channel along the length of each channel. Note that the length of a channel can be different to the characteristic length of a focusing apparatus. For example, a channel, such as channel 1336 in FIG. 6, can comprise several individual focusing apparatuses, such as focusing apparatus 1339 or focusing apparatus 1343. The characteristic length of focusing apparatus 1339 can be considered to be the distance between the first opening 1337 and the first internal opening 1342 measured along the Y-axis. In this case, the characteristic dimension can be considered to be approximately equal to the characteristic length of focusing apparatus 1339.

The length of channel 1336 in FIG. 6 is the distance of separation between the first opening 1337 and the second opening 1338 of channel 1336, where the first opening 1337 describes the interface between channel 1336 and the first reservoir 1330, and the second opening 1338 describes the interface between channel 1336 and the second reservoir 1331. Since channel 1336 is axially symmetric about a central axis, the line which describes the centroid of channel 1336 is straight and parallel to the Y-axis. The length of channel 1336 in this particular embodiment is therefore also equal to the shortest distance between the first opening 1337 and the second opening 1336. Since the first surface 1333 and the second surface 1334 are planar and parallel to the XZ-plane, the length of channel 1336 in this particular embodiment is also equal to the shortest distance between the first surface 1333 and the second surface 1334. The distance between the first surface 1333 and the second surface 1334 can also be referred to as the height of the depicted apparatus, as mentioned.

In another example, the length of channel 1285 in FIG. 5 is the length of the line which describes the centroid of channel 1285. Since channel 1285 merges with channel 1274, the centroid of channel 1285 merges with the centroid of channel 1274. The length of channel 1285 is therefore the length of the centroid of the channel between the first opening 1286 of channel 1285 and the second opening 1278 of channel 1285, which is also the second opening 1278 of channel 1274. The first opening 1286 of channel 1285 is the interface between channel 1285 and the first reservoir 1270. Similarly, the length of channel 1290 is the length of the centroid of the channel between the first opening 1291 of channel 1290, which is located at the interface between channel 1290 and the first reservoir 1270, and the second opening 1278 of channel 1290, which is located at the interface between channel 1290, which has merged with channel 1274, and the first reservoir 1270. The second opening 1278 of channel 1290 is also the second opening 1278 of channel 1274.

In some embodiments the channel system comprising channels 1274, 1285, 1290, and any other channels which merge with channel 1274, can be considered to be a focusing apparatus. In this case, the characteristic length of this channel system, or focusing apparatus, is the average length of all channels associated with the channel system. In other embodiments, a focusing apparatus can be considered to consist of only the junction between two or more channels which merge into a single channel, and adjacent portions of the merging and merged channels. In such embodiments, the characteristic length of a channel can be shorter than the length of a channel.

For each of the embodiments in FIGS. 1-7 the “characteristic dimension” has been defined. In some example embodiments, the characteristic dimension of a focusing apparatus, or a channel segment, or a surface feature, of a filtering apparatus is smaller than a number several orders of magnitude larger than the smallest mean fee path of objects of interest within an adjacent reservoir, such as first reservoir 1270, or second reservoir 1331. In accordance with some embodiments, the characteristic dimension is smaller than a value three orders of magnitude larger than the smallest mean fee path of objects of interest within an adjacent reservoir. In other words, the ratio of the smallest mean free path of an object of interest in an adjacent reservoir to the characteristic dimension is larger than 0.001 in some embodiments.

The ratio of the mean free path of an object of interest in a specified reservoir to the characteristic dimension of a focusing apparatus is denoted the “relative length”, or “RL”. Unless otherwise specified, the medium or the reservoir which provides the mean free path in the calculation of the RL is the medium or reservoir with the smallest mean free path. The mean free path is measured adjacent to the filtering apparatus or to the channel opening. The mean free path is measured exclusively within the medium, i.e. exclusively between collisions of objects of interest with other objects, i.e. objects other than the bulk material of the filtering apparatus or objects other than objects associated with, or employed by, the filtering apparatus. The relative length describes the size of the focusing apparatus relative to the properties of the surrounding medium. In embodiments in which the medium can be described as a fluid, this ratio can be referred to as the Knudsen number.

For RL which are multiple orders of magnitude smaller than 0.001, the focusing effect of the focusing apparatus can be non-zero, but negligibly small. In other example embodiments of the invention, the RL can be 0.01. The RL can also be 0.1, for example. The RL can be 1 in another example. The RL can be 10 in another example. The RL can also be larger than 10. In general, a larger RL increases the performance of the focusing apparatus or filtration system, but increases the complexity or difficulty of manufacture. An increase in the characteristic dimension relative to the mean free path of objects of interest in an adjacent reservoir can increase the probability of scattering of objects of interest as they travel through the filtering apparatus or interact with the focusing apparatus. This can reduce the focusing or redirection effect of the filtering apparatus on the trajectories of objects of interest, and reduce the performance of the filtering apparatus.

For example, the mean free path of nitrogen gas at standard temperature and pressure is approximately 60 nanometers. For applications of a filtering apparatus in which the objects of interest are nitrogen atoms, and in which the first, and, if applicable, second reservoirs, are at standard temperature and pressure, the characteristic dimension can be smaller than 60 micrometers in some embodiments. For instance, the characteristic dimension can be about 60 nanometers, where “about” and “approximately” as used herein refer to a value within plus or minus 30% of the stated figure. In another example filtering apparatus, the characteristic dimension can be about 6 micrometers. The characteristic dimension associated with another embodiment can be about 600 nanometers, for example. The characteristic dimension associated with another embodiment can be about 6 micrometers, for example.

In another example, the mean free path of electrons in the conduction band in copper can be considered to be approximately 40 nanometers. In embodiments of a filtering apparatus in which the objects of interest are electrons, the bulk material, such as bulk material 1405, or bulk material 1102, or bulk material 1182, can comprise an electrical insulator. The bulk material can optionally comprise material with a reflectivity which is greater than zero with respect to electrons. In these and other example embodiments, the bulk material can comprise material with a different refractive index with respect to objects of interest, i.e. electrons in this case, for example. In embodiments of the invention in which the objects of interest are electrons in the conduction band, and in which the medium in the first and second reservoir is copper, the characteristic dimension associated with some embodiments can be less than or equal to 40 micrometers, for example. For instance, the characteristic dimension can be less than or approximately equal to 400 nanometers. The characteristic dimension associated with some embodiments can alternatively be about 40 nanometers, for example. The characteristic dimension of a filtering apparatus or a focusing apparatus can be approximately 4 micrometers, for instance. The characteristic dimension of a filtering apparatus or a focusing apparatus can be approximately 4 nanometers, in another example.

For embodiments in which the objects of interest behave like waves, such as photons, phonons, acoustic waves, or ocean waves, for example, the mean free path can be very large, possibly even infinitely large. For very large values of mean free path, some objects of interest rarely or never scatter within a medium, such as a first reservoir or a second reservoir. This can be due to the superposition principle, which applies to some wave types. Since the mean free path of some of these objects of interest is larger than the mean free path in the aforementioned examples, the characteristic dimension of the embodiments can be larger as well. This can significantly reduce the complexity associated with the manufacture of a filtering apparatus. A sufficiently large ratio of the mean free path relative to the characteristic dimension of the filtration apparatus should preferably be maintained.

A medium can be located in a first reservoir, a second reservoir, and/or the interior of a channel, such as the example channel 1274 in FIG. 5, or channel 1336 in FIG. 6, or the interior of a focusing apparatus. The characteristic dimension of a filtering apparatus which is configured to interact with photons can be about ten meters, for example. The characteristic dimension can be about 1 centimeter in another example. The characteristic dimension can be serval nanometers in another example. The focusing portions of the example embodiments shown in the figures function in a manner comparable to optical telescopes or solar concentrators, for instance. In other embodiments, lenses can be used to perform the focusing of the trajectories of objects of interest. The lenses can employ refraction or diffraction, for example. As mentioned, in such embodiments, the objects of interest can be waves or wavelike particles, such as acoustic waves, ocean waves, gravity waves, phonons, photons or electrons. The calculation of the mean free path of photons in the medium surrounding and enveloping the bulk material in a filtering apparatus preferably takes into account photon-object scattering, i.e. collision between photons and other objects in the medium, such as air molecules. This effect can be mitigated by evacuating the portion of the filtering apparatus which is concerned with the focusing of the objects of interest, e.g. the photons, by removing, or reducing the concentration of, other objects of interest, e.g. air molecules, which would otherwise interfere with, and reduce the mean free path of, the objects of interest. For example, the focusing portion of the filtering apparatus, such as the example channel system in FIG. 5, can be located in a vacuum, or a region of reduced density of objects of interest, or any other objects which can unintentionally scatter an object of interest.

The manner in which a filtration apparatus is manufactured depends on the scale or the characteristic dimension of a filtration apparatus. For example, consider an application example in which the mean free path of objects of interest in a medium is about one millimeter. The characteristic dimension of an example embodiment of a filter system for such an application can be about one centimeter. Structures of this scale can be readily manufactured and mass produced using conventional mechanical manufacturing techniques, such as computer numerical controlled (CNC) mills, selective laser sintering (SLS), photolithography and etching, additive printing processes, and so on.

Embodiments of a filtering apparatus for which the characteristic dimension is on the order of nanometers can be manufactured with semiconductor manufacturing equipment and procedures. For example, grayscale electron beam or ion beam lithography can be employed to manufacture molds with large arrays of repeating patterns of complex geometry at the nanometer scale. These molds can be employed to imprint the desired surface features on a substrate using nanoimprint lithography. This method can be employed to manufacture embodiments as shown in the examples of FIGS. 1-4, for example. In another example, embodiments can be manufactured using nanometer scale additive manufacturing techniques, such as electron beam induced deposition. These and other manufacturing techniques can benefit from interference effects to manufacture the aforementioned large arrays of complex structures. These methods are known in the field of interference lithography, for example. Such methods can be employed to manufacture embodiments similar to the embodiments shown in FIGS. 5-7, for instance. Subtractive manufacturing techniques such as deep reactive ion etching can be employed to manufacture channels of filtration apparatuses of the type shown in FIGS. 5-7. In the manufacture of some embodiments, subtractive and additive manufacturing techniques can be employed. For instance, individual channel segments, such as channel segment 1339 or channel segment 1343, can be manufactured using subtractive manufacturing techniques, while sequential layers of bulk material, such as the bulk material 1335 can be deposited using additive manufacturing techniques.

In some embodiments of the invention, the objects of interest are virtual particles, as described by quantum field theory. One can consider the quantum vacuum to be a medium comprising virtual objects, where a virtual object refers to a fluctuation in the quantum vacuum which temporarily exhibits some or all of the properties of a corresponding conventional or real object. Examples of virtual objects are virtual photons, or virtual particle-antiparticle pairs such as electrons and positrons. The quantum vacuum can instantaneously exhibit any of the properties of a particle or wave, such as mass or momentum. In the context of embodiments of the invention, no distinction is made between conventional objects, such as photons, and virtual objects, such as virtual photons. For simplicity, the term “vacuum” is used to refer to the quantum vacuum described by quantum field theory. These virtual particles give rise to the zero point energy and associated effects, such as the Casimir effect.

Embodiments of the invention which interact with the quantum vacuum can be configured as follows. The characteristic size of a filtering apparatus segment, the characteristic length or depth, and the characteristic width of a channel, are configured to be less than the length of 1000 mean free paths of virtual particles. In other words, the characteristic size of a filtering apparatus segment is configured in a manner in which the Casimir forces between components of the invention, e.g. between opposing or adjacent walls of a segment, are non-negligible. In other words, the characteristic size of a filtering apparatus segment is configured in a manner in which the zero point energy between components of the invention, e.g. between opposing walls of a channel, is changed from the undisturbed, vacuum level of the zero point energy by a non-negligible amount.

The vacuum can be considered to consist of virtual particles, such as virtual photons, which travel a certain distance or exist of a period of time before annihilating with another virtual particle. An annihilation event can be considered to be a scattering event of an OI, as discussed herein. The average path travelled by a virtual particle, such as a virtual photon, between annihilation or extinction events can be considered to be the mean free path of a virtual particle, as discussed herein. The average duration of existence of a virtual photon, or other virtual particle, can be considered to be the mean free time of the particle, i.e. the average time between the collision between the particle and another particle. The mean free path of virtual particles is within several orders of magnitude of one nanometer. For example, the Casimir pressure between two opposing, perfectly conducting plates is approximately equal to one atmosphere at separations of approximately 10 nanometers.

The geometry of a filtering apparatus segment which interacts with the quantum vacuum can be any suitable geometry discussed herein. For example, a filtering apparatus segment can be configured in a manner described in the context of FIGS. 1-8. In the following paragraphs, for convenience and clarity of description, the example embodiment which will be discussed is an embodiment configured in a similar manner as the embodiment in FIG. 3.

All surfaces of bulk material of the filtering apparatus segment, such as bulk material 2065 or bulk material 1102 or bulk material 1182, are perfectly conductive in this embodiment and in the context of objects of interest being virtual particles. In other embodiments, this need not be the case. Bulk material 1182 can be a superconducting material, or a conventionally conducting material such as metal, a semiconductor such as silicon, or an insulator such as glass. In other embodiments, the surface of bulk material can also be coated in a different material with intended properties.

If the maximization of an objective, such as the maximization of a thrust force on the filtration system, favors a high electrical conductivity, coating materials such as copper, silver, or graphene can be used. The bulk material is neutrally charged in this simplified embodiment. In the case in which the bulk material 1182 is a metal, a metal with a large plasmon frequency, such as Aluminium, can be used. This ensures that the range of frequencies over which the reflectivity of the bulk material is greater than zero is maximized, which ensures that the filtering apparatus segment can interact with a wide range of frequencies of virtual particles such as virtual photons, such that the objective is maximized, e.g. the thrust or shear stress in the negative X-direction in FIG. 3, or the axial pressure in the positive Y-direction in FIGS. 6-8.

For a dynamic boundary condition, virtual objects can interact with the filtering apparatus segment in a manner in which there is a net diffusion of virtual objects in the positive X-direction FIG. 3. This can result in a net force on the filtering apparatus segment in the negative X-direction. The value of this force per unit area in the XZ-plane is denoted the shear stress. For example, when the virtual particles are virtual photons, the origin of this shear stress is the radiation pressure of virtual photons which are redirected or focused by the filtering apparatus segment within the mean free path of these virtual photons. The radiation pressure of virtual objects acting on the surfaces of the filtering apparatus segment, such as surface 1185 and surface 1186 can give rise to a net force or a net shear stress along the negative X-direction. The size and shape of a channel, as well as other parameters, such as the conductivity of the bulk material, affect the magnitude of this shear stress.

The magnitude and direction of the shear stress for a particular geometry and size of an apparatus unit can be calculated using methods known in the art. For example, such methods have been developed for calculating the Casimir interaction between two bodies of arbitrary geometry. These algorithms can be adapted to the types of geometries provided in or within the scope of the invention. The appropriate geometry and size of an embodiment for a particular application can be found using standard optimization techniques.

There are a wide variety of applications of such an apparatus. For example, the shear stress can be used to do mechanical work, which can be converted into electrical energy by an electric generator. Embodiments of the invention can also be considered for applications involving the pumping of zero-point energy. Consider a scenario in which the apparatus shown in FIGS. 6-7 forms an interface between two otherwise isolated reservoirs. In such cases, embodiments of the invention can be employed to decrease the zero-point energy in a first reservoir and increase it correspondingly in a second reservoir. The first and second reservoirs are assumed to be finite in size, and are assumed to initially be at the default boundary condition, i.e. the zero-point energy in the first and second reservoirs is initially substantially equal to the zero-point energy of free space. Over time, the embodiment of the invention will reduce the zero-point energy in the first reservoir, and increase the zero-point energy in the second reservoir correspondingly. Eventually, a new steady-state configuration is reached, in which the zero-point energy in any reservoir is approximately constant in time.

Filtering apparatus segments configured to interact with the quantum vacuum have a wide variety of applications. For example, such filtering apparatus segments can be configured to produce thrust by interacting with and inducing a bulk flow of virtual particles. Such an engine can be configured to produce thrust in the vacuum of space. Embodiments of the invention can therefore be used to power or propel spacecraft or rockets. In such applications, the filtering apparatus segment can be mounted in place of conventional, chemical rockets on the spacecraft or rockets, for example.

A filtering apparatus segment which interacts with the quantum vacuum or any other type of medium can also be mounted on a rotating shaft of an electric generator, and apply a torque on the shaft. Thus a filtering apparatus segment can be employed to turn the shaft and apply power to the electric generator, which can convert the power into electricity. In such configurations, the filtering apparatus segment can perform the same function and be arranged similarly as a turbine blade on a wind turbine. The X-axis of the filtering apparatus segment, such as the filtering apparatus segment shown in FIG. 3, can be arranged parallel to the local flow of OI relative to the filtering apparatus segment.

### Aspects of the Invention

The invention is further defined by the following aspects.

Aspect 1. A filtration system configured to interact with objects of interest in a medium in a manner in which the difference between the average net rate of change of momentum of objects of interest which interact with the filtration system and the average net rate of change of momentum of objects of interest which interact with a baseline filtration system in a baseline scenario has a non-zero component in a specified direction, wherein the medium comprising the objects of interest forms a first reservoir

Aspect 2. The filtration system of aspect 1, wherein the component of the difference along the specified direction can be negative.

Aspect 3. The filtration system of aspect 1, wherein the set of objects of interest comprises a particle, a photon, an electron, an atom, a molecule, a dust particle, a pollen, an aerosol, a soot particle, an ice particle, a water droplet, a water molecule, a large molecule, a small molecule, a charged particle, an ion, and a quasiparticle such as electron holes in a semiconductor.

Aspect 4. The filtration system of aspect 1, wherein the set of objects of interest comprises a virtual particle, such as virtual photons, virtual electrons, virtual positrons

Aspect 5. The filtration system of aspect 1, wherein the set of objects of interest comprises a wave, an acoustic wave, an ocean wave, a gravitational wave, a seismic wave, a phonon, a longitudinal wave, a transverse wave, a polarizable wave or another distinct portion of a medium, or a combination thereof

Aspect 6. The filtration system of aspect 1, wherein a medium can be a gas, a liquid, a solid, a plasma, a vacuum, an electrical conductor, a semi-conductor, or a combination thereof

Aspect 7. The filtration system of aspect 1, wherein the specified direction is at a specified angle and azimuth to the outside normal to a specified average surface of a filtration system

Aspect 8. The filtration system of aspect 7, wherein the specified angle is larger than 60 degrees and smaller than 90 degrees

Aspect 9. The filtration system of aspect 7, wherein the specified angle is larger than or equal to 0 degrees and smaller than 30 degrees

Aspect 10. The filtration system of aspect 7, wherein the specified angle is substantially 0 degrees

Aspect 11. The filtration system of aspect 7, wherein the specified angle is substantially 90 degrees

Aspect 12. The filtration system of aspect 1, wherein the difference in the average net momentum change comprises a difference in transmissivity, where the transmissivity of an object of interest is the probability of an object of interest having a velocity with a direction within a first specified range of directions immediately after interacting with the filtration system given that the object of interest had a velocity with a direction outside the first specified range of directions immediately prior to interacting with the filtration system, where the first specified range of directions comprise a specified range of angle to the outside normal of the average surface and a specified range of azimuth angle about the outside normal of the average surface of a filtration system

Aspect 13. The filtration system of aspect 12, wherein the specified azimuth is 180 degrees, and the specified angle is 90 degrees

Aspect 14. The filtration system of aspect 12, wherein the specified azimuth is 90 degrees, and the specified angle is 90 degrees

Aspect 15. The filtration system of aspect 12, wherein the specified azimuth is 60 degrees, and the specified angle is 60 degrees

Aspect 16. The filtration system of aspect 12, wherein the specified azimuth is 360 degrees, and the specified angle is 90 degrees

Aspect 17. The filtration system of aspect 16, wherein a first transmissivity is the probability of an object of interest traveling through a filtration system from a first reservoir to a second reservoir, and wherein a second transmissivity is the probability of an object of interest traveling through a filtration system from a second reservoir to a first reservoir

Aspect 18. The filtration system of aspect 1, wherein the difference in the average net momentum change comprises a difference in the average net change of the velocity vector of objects of interest relative to the baseline scenario, where the component of the average net change of the velocity vector of objects of interest along the specified direction is larger compared to the baseline scenario

Aspect 19. The filtration system of aspect 1, wherein the difference in the average net momentum change comprises a difference in the average net change of the velocity vector of objects of interest, where the component of the average velocity vector of objects of interest after interacting with the filtration system along the specified direction is larger than in the baseline scenario

Aspect 20. The filtration system of aspect 1, wherein at least a portion of the difference in average net momentum change of the objects of interest is facilitated by a collision of at least one object of interest with a surface of a filtering apparatus

Aspect 21. The filtration system of aspect 1, wherein at least a portion of the surface within a segment of a filtering apparatus has a surface normal with a non-zero and positive component towards a specified direction

Aspect 22. The filtration system of aspect 1, wherein at least a portion of the difference in average net momentum change of the objects of interest is facilitated by a preferential deflection of objects of interest in a direction with a non-zero component in the specified direction

Aspect 23. The filtration system of aspect 1, wherein the filtration system comprises a first surface with a first outward surface normal, a second surface with a second outward surface normal, an average surface with an average outward surface normal, the first surface and the second surface forming a segment, wherein the first outward surface normal has a first angle relative to the average outward surface normal, and the second outward surface normal has a second angle relative to the average outward surface normal, and the first inward surface normal has a first inward angle relative to the average outward surface normal, and the second inward surface normal has a second inward angle relative to the average outward surface normal; wherein the segment has a depth measured parallel to the average outward surface normal, and a length measured perpendicular to the average outward surface normal, wherein a length is less than 1000 times the mean free path of objects of interest in an adjacent reservoir

Aspect 24. The filtration system of aspect 23, wherein the first angle is larger than zero and less than 90 degrees, and the second angle is larger than the first angle

Aspect 25. The filtration system of aspect 24, wherein the second angle is within 20 degrees of 90 degrees

Aspect 26. The filtration system of aspect 24, wherein the second angle is larger than zero and smaller than 90 degrees

Aspect 27. The filtration system of aspect 24, wherein the first angle is larger than 0 degrees and smaller than 50 degrees

Aspect 28. The filtration system of aspect 23, wherein the depth is larger than 1000 times the mean free path of objects of interest in an adjacent reservoir

Aspect 29. The filtration system of aspect 23, wherein the depth is less than 1000 times the mean free path of objects of interest in an adjacent reservoir

Aspect 30. The filtration system of aspect 23, wherein the depth is less than 100 times the mean free path of objects of interest in an adjacent reservoir

Aspect 31. The filtration system of aspect 23, wherein the depth is less than 10 times the mean free path of objects of interest in an adjacent reservoir

Aspect 32. The filtration system of aspect 23, wherein the depth is less than 1 times the mean free path of objects of interest in an adjacent reservoir

Aspect 33. The filtration system of aspect 23, wherein the length is less than 100 times the mean free path of objects of interest in an adjacent reservoir

Aspect 34. The filtration system of aspect 23, wherein the length is less than 10 times the mean free path of objects of interest in an adjacent reservoir

Aspect 35. The filtration system of aspect 23, wherein the length is less than 1 times the mean free path of objects of interest in an adjacent reservoir

Aspect 36. The filtration system of aspect 23, wherein the length is measured along a direction with a non-zero component along the specified direction

Aspect 37. The filtration system of aspect 23, wherein the length is measured along the specified direction

Aspect 38. The filtration system of aspect 23, wherein the ratio of the length to the depth is larger than 0.1

Aspect 39. The filtration system of aspect 23, wherein the ratio of the length to the depth is larger than 1

Aspect 40. The filtration system of aspect 23, wherein the ratio of the length to the depth is larger than 10

Aspect 41. The filtration system of aspect 23, wherein the first surface normal has a non-zero component along the specified direction

Aspect 42. The filtration system of aspect 23, wherein the first surface normal has a non-zero and positive component along the specified direction

Aspect 43. The filtration system of aspect 23, wherein the first surface is configured to focus at least a portion of the trajectories of objects of interest which interact with the first surface within a distance less than 1000 mean free paths of objects of interest

Aspect 44. The filtration system of aspect 43, wherein the first surface comprises a concave portion

Aspect 45. The filtration system of aspect 23, wherein the first surface comprises a convex portion

Aspect 46. The filtration system of aspect 23, and aspect 1, wherein there can be a bulk flow of objects of interest relative to the filtration system

Aspect 47. The filtration system of aspect 46, wherein at least a portion of the bulk flow of objects of interest relative to the filtration system is induced by the filtration system

Aspect 48. The filtration system of aspect 23, wherein the second surface comprises a concave or convex portion

Aspect 49. The filtration system of aspect 23, wherein the first angle is larger than 90 degrees and less than 180 degrees, and wherein the second angle is larger than 0 degrees and less than 180 degrees, and wherein an average inclination angle is the average of the first angle and the second inward angle, wherein the average inclination angle is larger than or equal to 90 degrees and less than 180 degrees, and wherein the internal angle is the difference between the first angle and the second inward angle

Aspect 50. The filtration system of aspect 49, wherein the first angle is smaller than the second inward angle, or the internal angle is negative

Aspect 51. The filtration system of aspect 49, wherein the first angle is larger than the second inward angle, or the internal angle is positive

Aspect 52. The filtration system of aspect 51, wherein a segment also comprises a third surface which joins the first surface and the second surface

Aspect 53. The filtration system of aspect 49, wherein the second angle is larger than 0 degrees and less than 90 degrees

Aspect 54. The filtration system of aspect 49, wherein the internal angle magnitude is less than 15 degrees

Aspect 55. The filtration system of aspect 49, wherein the internal angle magnitude is less than 30 degrees

Aspect 56. The filtration system of aspect 49, wherein the internal angle magnitude is less than 50 degrees

Aspect 57. The filtration system of aspect 49, wherein the internal angle magnitude is less than 70 degrees

Aspect 58. The filtration system of aspect 49, wherein the internal angle magnitude is less than 100 degrees

Aspect 59. The filtration system of aspect 49, wherein the average inclination angle is less than 105 degrees

Aspect 60. The filtration system of aspect 49, wherein the average inclination angle is less than 120 degrees

Aspect 61. The filtration system of aspect 49, wherein the average inclination angle is less than 140 degrees

Aspect 62. The filtration system of aspect 49, wherein the average inclination angle is less than 160 degrees

Aspect 63. The filtration system of aspect 49, wherein the average inclination angle is less than 170 degrees

Aspect 64. The filtration system of aspect 49, wherein the first angle is 120 degrees and the second inward angle is 140 degrees

Aspect 65. The filtration system of aspect 49, wherein at least a portion of the first surface is concave

Aspect 66. The filtration system of aspect 65, wherein at least a portion of the second surface is concave

Aspect 67. The filtration system of aspect 65, wherein at least a portion of the second surface is convex

Aspect 68. The filtration system of aspect 49, wherein at least a portion of the first surface is convex

Aspect 69. The filtration system of aspect 68, wherein at least a portion of the second surface is concave

Aspect 70. The filtration system of aspect 68, wherein at least a portion of the second surface is convex

Aspect 71. The filtration system of aspect 1, wherein the filtration system comprises a first surface with a first outward surface normal, a second surface with a second outward surface normal, a third surface with a third outward surface normal, an average surface with an average outward surface normal, the first surface, the second surface, and the third surface forming a segment, the second surface combining the first surface with the third surface, wherein the first outward surface normal has a first angle relative to the average outward surface normal, the second outward surface normal has a second angle relative to the average outward surface normal, and the third outward surface normal has a third angle relative to the average outward surface normal, and the first inward surface normal has a first inward angle relative to the average outward surface normal, the second inward surface normal has a second inward angle relative to the average outward surface normal, and the third inward surface normal has a third inward angle relative to the average outward surface normal; wherein the segment has a depth measured parallel to the average outward surface normal, and a length measured perpendicular to the average outward surface normal, wherein the depth or the length are less than 1000 times the mean free path of objects of interest in an adjacent reservoir

Aspect 72. The filtration system of aspect 71, wherein the first surface is configured to defocus the trajectories at least a portion of objects of interest which interact with the first surface within a distance less than 1000 mean free paths of objects of interest

Aspect 73. The filtration system of aspect 72, wherein at least a portion of the first surface is convex

Aspect 74. The filtration system of aspect 71, wherein the second surface is configured to focus the trajectories at least a portion of objects of interest which interact with the second surface within a distance less than 1000 mean free paths of objects of interest

Aspect 75. The filtration system of aspect 74, wherein at least a portion of the second surface is concave

Aspect 76. The filtration system of aspect 71, wherein the third surface is configured to focus the trajectories of at least a portion of objects of interest which interact with the third surface within a distance less than 1000 mean free paths of objects of interest

Aspect 77. The filtration system of aspect 76, wherein at least a portion of the third surface is concave

Aspect 78. The filtration system of aspect 76, wherein the third surface is configured to focus at least a portion of the trajectories objects of interest which interact with the third surface onto the first surface

Aspect 78. The filtration system of aspect 71, wherein the first angle is larger than 0 degrees and smaller than 180 degrees

Aspect 79. The filtration system of aspect 78, wherein the first angle is larger than 60 degrees and smaller than 120 degrees

Aspect 80. The filtration system of aspect 78, wherein the first angle is larger than 30 degrees and smaller than 150 degrees

Aspect 81. The filtration system of aspect 71, wherein the second angle is larger than 0 degrees and smaller than 90 degrees

Aspect 82. The filtration system of aspect 81, wherein the second angle is larger than 20 degrees.

Aspect 83. The filtration system of aspect 81, wherein the second angle is larger than 40 degrees.

Aspect 84. The filtration system of aspect 81, wherein the second angle is larger than 60 degrees.

Aspect 85. The filtration system of aspect 71, wherein the third angle is larger than 0 degrees and smaller than 180 degrees.

Aspect 86. The filtration system of aspect 85, wherein the third angle is larger than 40 degrees and smaller than 140 degrees

Aspect 87. The filtration system of aspect 85, wherein the third angle is 50 degrees.

Aspect 88. The filtration system of aspect 71, wherein the first surface normal has a non-zero component along the specified direction

Aspect 89. The filtration system of aspect 88, wherein the first surface normal has a non-zero and positive component along the specified direction

Aspect 90. The filtration system of aspect 1, wherein the filtration system comprises a channel system with a first opening to a first reservoir, and a second opening to a first reservoir, wherein the first opening and the second opening are diffusively coupled by a channel system, wherein the channel system comprises at least one input channel, and at least one output channel, wherein the first opening comprises at least one input channel opening, and wherein the second opening comprises at least one output channel opening, wherein the first opening is the sum of the input channel openings, and wherein the second opening is the sum of the output channel openings, and wherein all channels within a channel system are diffusively coupled to all other channels within a channel system between the first opening and the second opening

Aspect 91. The filtration system of aspect 90, wherein the channel system is configured to focus the trajectories of objects of interest diffusing in the direction from first opening to the second opening within at least a portion of the channel system, wherein the focusing occurs within a distance less than 1000 mean free paths of the objects of interest

Aspect 92. The filtration system of aspect 91, wherein the focusing is accomplished at least in part by a merging of two or more channels into a single channel along the direction of travel of the objects of interest in question

Aspect 93. The filtration system of aspect 91, wherein the focusing is accomplished at least in part by an increase in the cross-sectional area of a channel or channel system along the length of a channel or channel system and in the direction of travel of the objects of interest in question and within a distance less than 1000 mean free paths of the objects of interest

Aspect 94. The filtration system of aspect 93, wherein the increase in average cross-sectional area of the channel or channel system is at an increasing rate, a constant rate, or a decreasing rate along the length of the channel

Aspect 95. The filtration system of aspect 91, wherein the focusing is accomplished at least in part by convex refractive lenses

Aspect 96. The filtration system of aspect 90, wherein the channel system is configured to defocus the trajectories of objects of interest diffusing in the direction from second opening to the first opening within at least a portion of the channel system, wherein the defocusing occurs within a distance less than 1000 mean free paths of the objects of interest

Aspect 97. The filtration system of aspect 96, wherein the defocusing is accomplished at least in part by a forking of one channel into two or more channels along the direction of travel of the objects of interest in question

Aspect 98. The filtration system of aspect 96, wherein the defocusing is accomplished at least in part by a decrease in the cross-sectional area of a channel or channel system along the length of a channel or channel system and in the direction of travel of the objects of interest in question and within a distance less than 1000 mean free paths of the objects of interest

Aspect 99. The filtration system of aspect 98, wherein the decrease in average cross-sectional area of the channel or channel system is at an increasing rate, a constant rate, or a decreasing rate along the length of the channel

Aspect 100. The filtration system of aspect 96, wherein the defocusing is accomplished at least in part by concave refractive lenses

Aspect 101. The filtration system of aspect 90, wherein the characteristic width of a channel in the channel system is less than 1000 times the smallest mean free path of objects of interest in an adjacent reservoir

Aspect 102. The filtration system of aspect 90, wherein a bulk flow is generated through the channel system

Aspect 103. The filtration system of aspect 90, wherein the average direction of the bulk flow entering the first opening and exiting the second opening has a non-zero component along the specified direction

Aspect 104. The filtration system of aspect 1, wherein the filtration system comprises a channel system comprising at least one channel, the channel comprising a first opening to a first reservoir and a second opening to a second reservoir, wherein the channel diffusively couples the first reservoir to the second reservoir, the channel comprising at least one segment, each segment comprising a first segment opening and a second segment opening, each segment comprising a first surface with a first outward surface normal, a second surface with a second outward surface normal, an average surface with an average outward surface normal, the first surface and the second surface forming the segment, wherein the first outward surface normal has a first angle relative to the average outward surface normal, and the second outward surface normal has a second angle relative to the average outward surface normal, and the first inward surface normal has a first inward angle relative to the average outward surface normal, and the second inward surface normal has a second inward angle relative to the average outward surface normal; wherein the segment has a depth measured parallel to the average outward surface normal, and a length measured perpendicular to the average outward surface normal, wherein the length is less than 1000 times the mean free path of objects of interest in an adjacent reservoir, and wherein the characteristic width of a channel in at least a portion of a segment is less than 1000 times the smallest mean free path of objects of interest at that location

Aspect 105. The filtration system of aspect 104, wherein the first surface in a segment is configured to focus the trajectories of objects of interest diffusing in the direction from first opening to the second opening, wherein the focusing occurs within a distance less than 1000 mean free paths of the objects of interest

Aspect 106. The filtration system of aspect 105, wherein the first surface comprises a concave portion

Aspect 107. The filtration system of aspect 104, wherein the first surface comprises a convex portion

Aspect 108. The filtration system of aspect 104, wherein the second surface comprises a convex or concave portion

Aspect 109. The filtration system of aspect 104, wherein the first angle is larger than zero and less than 90 degrees, and the second angle is larger than the first angle

Aspect 110. The filtration system of aspect 109, wherein the second angle is larger than 70 degrees and less than 110 degrees

Aspect 111. The filtration system of aspect 109, wherein the second angle is larger than zero and smaller than 90 degrees

Aspect 112. The filtration system of aspect 109, wherein the first angle is larger than 0 degrees and smaller than 50 degrees

Aspect 113. The filtration system of aspect 104, wherein the depth is larger than 1000 times the mean free path of objects of interest in an adjacent reservoir

Aspect 114. The filtration system of aspect 104, wherein the depth is less than 1000 times the mean free path of objects of interest in an adjacent reservoir

Aspect 115. The filtration system of aspect 104, wherein the depth is less than 100 times the mean free path of objects of interest in an adjacent reservoir

Aspect 116. The filtration system of aspect 104, wherein the depth is less than 10 times the mean free path of objects of interest in an adjacent reservoir

Aspect 117. The filtration system of aspect 104, wherein the depth is less than 1 times the mean free path of objects of interest in an adjacent reservoir

Aspect 118. The filtration system of aspect 104, wherein the length is less than 100 times the mean free path of objects of interest in an adjacent reservoir

Aspect 119. The filtration system of aspect 104, wherein the length is less than 10 times the mean free path of objects of interest in an adjacent reservoir

Aspect 120. The filtration system of aspect 104, wherein the length is less than 1 times the mean free path of objects of interest in an adjacent reservoir

Aspect 121. The filtration system of aspect 104, wherein the length is measured along a direction with a non-zero component along the specified direction

Aspect 122. The filtration system of aspect 104, wherein the length is measured along the specified direction

Aspect 123. The filtration system of aspect 104, wherein the ratio of the length to the depth is larger than 0.1

Aspect 124. The filtration system of aspect 104, wherein the ratio of the length to the depth is larger than 1

Aspect 125. The filtration system of aspect 104, wherein the ratio of the length to the depth is larger than 10

Aspect 126. The filtration system of aspect 104, wherein the first surface normal has a non-zero component along the specified direction

Aspect 127. The filtration system of aspect 104, wherein the first surface normal has a non-zero and positive component along the specified direction

Aspect 128. The filtration system of aspect 104, wherein there can be a bulk flow of objects of interest relative to the filtration system through the channel

Aspect 129. The filtration system of aspect 128, wherein at least a portion of the bulk flow of objects of interest relative to the filtration system is induced by the filtration system

Aspect 130. The filtration system of aspect 128, wherein the bulk flow is from the first reservoir to the second reservoir

Aspect 131. The filtration system of any one of aspects 1 to 103, wherein the first reservoir forms the interior of a channel, wherein the channel width is larger than 1000 times the mean free path of objects of interest in the first reservoir, wherein the interior wall of the channel comprises at least one filtering apparatus segment

Aspect 132. The filtration system of aspect 131, wherein the channel width is measured perpendicular to the average surface of the filtration apparatus segment

Aspect 133. The filtration system of aspect 131, wherein the channel width is the characteristic width of the channel, wherein the characteristic width is the smallest width of the channel

Aspect 134. The filtration system of aspect 131, wherein there is a bulk flow of objects of interest through the channel

Aspect 135. The filtration system of aspect 131, wherein the channel diffusively couples a second reservoir with a third reservoir

Aspect 136. The filtration system of aspect 1, wherein the average length of the path followed by an object of interest through the segment of a filtration apparatus is less than 1000 times the smallest mean free path of objects of interest in an adjacent reservoir

Aspect 137. The filtration system of aspect 1, wherein the average length of the path followed by an object of interest through the segment of a filtration apparatus is less than 100 times the smallest mean free path of objects of interest in an adjacent reservoir

Aspect 138. The filtration system of aspect 1, wherein the average length of the path followed by an object of interest through the segment of a filtration apparatus is less than 10 times the smallest mean free path of objects of interest in an adjacent reservoir

Aspect 139. The filtration system of aspect 1, wherein the average length of the path followed by an object of interest through the segment of a filtration apparatus is less than the smallest mean free path of objects of interest in an adjacent reservoir

Aspect 140. The filtration system of aspect 1, wherein the Knudsen number of a segment of a filtration system is greater than 0.001

Aspect 141. The filtration system of aspect 1, wherein the Knudsen number of a segment of a filtration system is greater than 0.01

Aspect 142. The filtration system of aspect 1, wherein the Knudsen number of a segment of a filtration system is greater than 0.1

Aspect 143. The filtration system of aspect 1, wherein the Knudsen number of a segment of a filtration system is greater than 1

Aspect 144. The filtration system of aspect 1, wherein segments within a filtration system are arranged in series along a direction with a non-zero component along the specified direction

Aspect 145. The filtration system of aspect 144, wherein segments within a filtration system are arranged in series along the specified direction

Aspect 145. The filtration system of aspect 1, wherein segments within a filtration system are arranged in series along a dimension parallel to the average surface

Aspect 146. The filtration system of aspect 144, wherein a second segment is located in a downstream direction of a first segment in the presence of a bulk flow of objects of interest

Aspect 147. The filtration system of aspect 1, wherein segments within a filtration system are arranged in parallel along a direction with a non-zero component perpendicular to the specified direction

Aspect 148. The filtration system of aspect 1, wherein segments within a filtration system are arranged in parallel along a dimension parallel to the average surface

Aspect 149. The filtration system of aspect 1, wherein segments within a filtration system are arranged in parallel along a dimension perpendicular to the average surface

Aspect 150. The filtration system of aspect 1, wherein a filtration system is configured to generate a bulk flow or net diffusion of objects of interest which are initially and instantaneously in a static boundary condition

Aspect 151. The filtration system of aspect 150, wherein the bulk flow velocity has a non-zero component along the specified direction for at least a portion of objects of interest

Aspect 152. The filtration system of aspect 1, wherein a filtration system is configured to increase in magnitude a bulk flow velocity of objects of interest relative to a baseline scenario in a dynamic boundary condition

Aspect 153. The filtration system of aspect 152, wherein a filtration system is configured to increase in magnitude a component of a bulk flow velocity of objects of interest along the specified direction relative to a baseline scenario in a dynamic boundary condition

Aspect 154. The filtration system of aspect 152, wherein the increase in magnitude of the flow velocity comprises an increase in the component of the momentum flux of the bulk flow along a specified direction

Aspect 155. The filtration system of aspect 152, wherein the increase in magnitude of the flow velocity comprises an increase in the component of the momentum flux of the bulk flow along a specified direction

Aspect 156. The filtration system of aspect 1, wherein a filtration system is configured to reduce the magnitude of a drag force acting on a surface comprising the filtration system relative to a baseline scenario

Aspect 157. The filtration system of aspect 156, wherein the drag force is a viscous drag force

Aspect 158. The filtration system of aspect 156, wherein the drag force has a non-zero component along the specified direction

Aspect 159. The filtration system of aspect 1, wherein a filtration system is configured to generate a thrust force acting on a surface comprising the filtration system

Aspect 160. The filtration system of aspect 159, wherein the thrust force has a non-zero component along the specified direction

Aspect 161. The filtration system of aspect 159, wherein the thrust force is employed to do mechanical work

Aspect 162. The filtration system of aspect 161, wherein at least a portion of the energy of the mechanical work is provided by the thermal energy of objects of interest interacting with the filtration system

Aspect 163. The filtration system of aspect 1, wherein the filtration system is located on the surface of the hull of a ship, the hull of a fuselage, the surface of a propeller blade, the surface of a vehicle, the surface of a car, truck, or train, or another object moving relative to a fluid.

Aspect 164. The filtration system of aspect 1, wherein an interaction between an object of interest and the filtration system comprises a specular reflection

Aspect 165. The filtration system of aspect 1, wherein an interaction between an object of interest and the filtration system comprises a diffuse reflection

Aspect 166. A method of interacting with objects of interest in a first reservoir, comprising: providing the filtering apparatus of any one of aspects 1 to 165, wherein objects of interest are able to interact with the filtering apparatus

Aspect 167. A method of transmitting objects of interest from a first reservoir to a second reservoir, comprising: providing the filtering apparatus of any one of aspects 104 to 130, wherein objects of interest are able to diffuse through the filtering apparatus from the first reservoir to the second reservoir and vice versa

Aspect 167. A method of transmitting objects of interest from a first reservoir to a second reservoir, comprising: providing the filtering apparatus of any one of aspects 131 to 135, wherein objects of interest are able to diffuse through the filtering apparatus from the second reservoir to the third reservoir and vice versa

Unless specified or clear from context, the term “or” is equivalent to “and/or” throughout this paper.

The embodiments and methods described in this paper are only meant to exemplify and illustrate the principles of the invention. This invention can be carried out in several different ways and is not limited to the examples, embodiments, arrangements, configurations, or methods of operation described in this paper or depicted in the drawings. This also applies to cases where just one embodiment is described or depicted. Those skilled in the art will be able to devise numerous alternative examples, embodiments, arrangements, configurations, or methods of operation, that, while not shown or described herein, embody the principles of the invention and thus are within its spirit and scope.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A filtration system, wherein the filtration system is configured to interact with objects of interest in a medium in a manner in which the difference between the average net rate of change of momentum of objects of interest which interact with the filtration system and the average net rate of change of momentum of objects of interest which interact with a baseline filtration system in a baseline scenario has a non-zero component in a specified direction, wherein the medium comprising the objects of interest forms a first reservoir.

2. The filtration system of claim 1, wherein the component of the difference along the specified direction can be negative.

3. The filtration system of claim 1, wherein the set of objects of interest comprises a particle, a photon, an electron, an atom, a molecule, a dust particle, a pollen, an aerosol, a soot particle, an ice particle, a water droplet, a charged particle, an ion, and a quasiparticle such as electron holes in a semiconductor.

4. The filtration system of claim 1, wherein the set of objects of interest comprises a virtual particle, such as virtual photons, virtual electrons, virtual positrons.

5. The filtration system of claim 1, wherein the set of objects of interest comprises a wave, an acoustic wave, an ocean wave, a gravitational wave, a seismic wave, a phonon, a longitudinal wave, a transverse wave, a polarizable wave.

6. The filtration system of claim 1, wherein a medium can be a gas, a liquid, a solid, a plasma, a vacuum, an electrical conductor, a semi-conductor.

7. The filtration system of claim 1, wherein there can be a bulk flow of objects of interest relative to the filtration system.

8. The filtration system of claim 7, wherein at least a portion of the bulk flow of objects of interest relative to the filtration system is induced by the filtration system.

9. The filtration system of claim 1, wherein an interaction between an object of interest and the filtration system comprises a specular reflection.

10. The filtration system of claim 1, wherein an interaction between an object of interest and the filtration system comprises a diffuse reflection.

11. The filtration system of claim 1, wherein the difference in the average net momentum change comprises a difference in the average net change of the velocity vector of objects of interest relative to the baseline scenario, wherein the component of the average net change of the velocity vector of objects of interest along the specified direction is larger compared to the baseline scenario.

12. The filtration system of claim 1, wherein the filtration system comprises a first surface with a first outward surface normal, a second surface with a second outward surface normal, an average surface with an average outward surface normal, the first surface and the second surface forming a segment,
wherein the first outward surface normal has a first angle relative to the average outward surface normal, and the second outward surface normal has a second angle relative to the average outward surface normal, and the first inward surface normal has a first inward angle relative to the average outward surface normal, and the second inward surface normal has a second inward angle relative to the average outward surface normal,
wherein the segment has a depth measured parallel to the average outward surface normal, and a length measured perpendicular to the average outward surface normal, wherein a length is less than 1000 times the mean free path of objects of interest in an adjacent reservoir.

13. The filtration system of claim 12, wherein the first angle is larger than zero and less than 90 degrees, and the second angle is larger than the first angle.

14. The filtration system of claim 13, wherein the second angle is larger than 70 degrees and smaller than 110 degrees.

15. The filtration system of claim 12, wherein the depth is less than 1000 times the mean free path of objects of interest in an adjacent reservoir.

16. The filtration system of claim 12, wherein the length is measured along a direction with a non-zero component along the specified direction.

17. The filtration system of claim 12, wherein the first surface normal has a non-zero and positive component along the specified direction.

18. The filtration system of claim 12, wherein the first surface is configured to focus at least a portion of the trajectories of objects of interest which interact with the first surface within a distance less than 1000 mean free paths of objects of interest.

19. The filtration system of claim 18, wherein the first surface comprises a concave portion.

20. The filtration system of claim 12, wherein the first angle is larger than 90 degrees and less than 180 degrees, and wherein the second angle is larger than 0 degrees and less than 180 degrees, and
wherein an average inclination angle is the average of the first angle and the second inward angle, wherein the average inclination angle is larger than or equal to 90 degrees and less than 180 degrees, and
wherein the internal angle is the difference between the first angle and the second inward angle.

21. The filtration system of claim 20, wherein the first angle is smaller than the second inward angle.

22. The filtration system of claim 20, wherein the first angle is larger than the second inward angle.

23. The filtration system of claim 22, wherein a segment also comprises a third surface which joins the first surface and the second surface

24. The filtration system of claim 20, wherein the internal angle magnitude is less than 50 degrees.

25. The filtration system of claim 20, wherein the average inclination angle is less than 140 degrees.

26. The filtration system of claim 20, wherein at least a portion of the first surface is concave.

27. The filtration system of claim 20, wherein at least a portion of the second surface is concave.

28. The filtration system of claim 1, wherein the filtration system comprises a channel system comprising at least one channel, the channel comprising a first opening to a first reservoir and a second opening to a second reservoir, wherein the channel diffusively couples the first reservoir to the second reservoir,
the channel comprising at least one segment, each segment comprising a first segment opening and a second segment opening, each segment comprising a first surface with a first outward surface normal, a second surface with a second outward surface normal, an average surface with an average outward surface normal, the first surface and the second surface forming the segment,
wherein the first outward surface normal has a first angle relative to the average outward surface normal, and the second outward surface normal has a second angle relative to the average outward surface normal, and the first inward surface normal has a first inward angle relative to the average outward surface normal, and the second inward surface normal has a second inward angle relative to the average outward surface normal,
wherein the segment has a depth measured parallel to the average outward surface normal, and a length measured perpendicular to the average outward surface normal, wherein the length is less than 1000 times the mean free path of objects of interest in an adjacent reservoir, and wherein the characteristic width of a channel in at least a portion of a segment is less than 1000 times the smallest mean free path of objects of interest at that location.

29. The filtration system of claim 28, wherein the first surface in a segment is configured to focus the trajectories of objects of interest diffusing in the direction from first opening to the second opening, wherein the focusing occurs within a distance less than 1000 mean free paths of the objects of interest.

30. The filtration system of claim 29, wherein the first surface comprises a concave portion.

31. The filtration system of claim 28, wherein the first angle is larger than zero and less than 90 degrees, and the second angle is larger than the first angle.

32. The filtration system of claim 28, wherein the depth is less than 1000 times the mean free path of objects of interest in an adjacent reservoir.

33. The filtration system of claim 28, wherein the length is measured along a direction with a non-zero component along the specified direction.

34. The filtration system of claim 1, wherein the first reservoir forms the interior of a channel, wherein the channel characteristic width is larger than 1000 times the mean free path of objects of interest in the first reservoir, wherein the interior wall of the channel comprises at least one filtering apparatus segment.

35. The filtration system of claim 34, wherein there is a bulk flow of objects of interest through the channel.

36. The filtration system of claim 34, wherein the channel diffusively couples a second reservoir with a third reservoir.

37. The filtration system of claim 1, wherein the Knudsen number of a segment of a filtration system is greater than 0.001.

38. The filtration system of claim 1, wherein segments within a filtration system are arranged in series along a direction with a non-zero component along the specified direction.

39. The filtration system of claim 38, wherein a second segment is located in a downstream direction of a first segment in the presence of a bulk flow of objects of interest.

40. The filtration system of claim 1, wherein segments within a filtration system are arranged in parallel along a direction with a non-zero component perpendicular to the specified direction.

41. The filtration system of claim 1, wherein a filtration system is configured to reduce the magnitude of a drag force acting on a surface comprising the filtration system relative to a baseline scenario.

42. The filtration system of claim 1, wherein a filtration system is configured to generate a thrust force acting on a surface comprising the filtration system.

43. The filtration system of claim 42, wherein the thrust force is employed to do mechanical work.

44. The filtration system of claim 43, wherein at least a portion of the energy of the mechanical work is provided by the thermal energy of objects of interest interacting with the filtration system.

45. The filtration system of claim 1, wherein the filtration system is located on the surface of the hull of a ship, the hull of a fuselage, the surface of a propeller blade, the surface of a vehicle, the surface of a car, truck, or train, or another object moving relative to a fluid.

46. A method of interacting with objects of interest in a first reservoir, comprising: providing the filtering apparatus of claim 1, wherein objects of interest are able to interact with the filtering apparatus.
